(19) United States
(12) Patent Application Publication
(10) Pub. No.: US 2015/0154155 A1
(43) Pub. Date: Jun. 4, 2015

(54) INFORMATION PROCESSING APPARATUS AND INFORMATION PROCESSING METHOD

(71) Applicant: FUJITSU LIMITED, Kawasaki-shi (JP)

(72) Inventors: Toshiaki TAKEUCHI, Nagano (JP); Shigeru TSUKADA, Inagi (JP)

(21) Appl. No.: 14/549,599

(22) Filed: Nov. 21, 2014

(30) Foreign Application Priority Data
Dec. 3, 2013 (JP) 2013-250204

(51) Int. Cl. G06F 17/22

(52) U.S. Cl. CPC G06F 17/227; G06F 17/2247

(57) ABSTRACT

A data acquisition unit acquires sets of display data for displaying information from an inside of an information processing apparatus and other information processing apparatuses. A data converter converts the acquired sets of display data into a single set of display data by a conversion method based on additional information respectively added to each set of display data, and transmits the converted set of display data to a display apparatus. Accordingly, pieces of information acquired from respective information processing apparatuses are collectively displayed on a display screen.

### CROSS-REFERENCE TO RELATED APPLICATION

This application is based upon and claims the benefit of priority of the prior Japanese Patent Application No. 2013-250204, filed on Dec. 3, 2013, the entire contents of which are incorporated herein by reference.

### FIELD

The embodiments discussed herein relate to an information processing apparatus and an information processing method.

### BACKGROUND

Methods of managing, by an administrator, a system in which a plurality of information processing apparatuses is operating include a method in which a terminal apparatus is connected to each information processing apparatus and the administrator operates the terminal apparatus to manage the system. According to the method, the administrator may, for example, display and check information which has been set for each information processing apparatus, on the terminal apparatus, or set various information for each information processing apparatus.

In addition, communication methods between such a terminal apparatus and each information processing apparatus include a method in which each information processing apparatus is operated as a Web server and the terminal apparatus is operated as a client. According to the method, the administrator requests an information processing apparatus via a Web browser on a terminal apparatus to perform a process, and may browse the processing result via the Web browser.

In addition, there exists a technique related to communication between a Web server and a client such as follows: For example, a virtual WWW (World Wide Web) server acquires sets of HTML (HyperText Markup Language) data from a plurality of WWW servers, combines the respective acquired sets of HTML data, and transmits the resultant data to the Web browser. Additionally, as another example, a user interface integration apparatus may acquire pages from a plurality of WWW servers, generate an integrated page, and transmit it to the WWW browser.

Japanese Laid-Open Patent Publication No. 11-85654

Japanese Laid-Open Patent Publication No. 2002-108756

In the aforementioned method in which each of the plurality of information processing apparatuses is operated as a Web server and the terminal apparatus is operated as a client, the terminal apparatus displays information for each information processing apparatus to the end. Accordingly, the administrator is not able to display pieces of information relating to the plurality of information processing apparatuses respectively, on a single screen and to browse the pieces of information at a time. In addition, the problem is not limited to the case using the WWW technique and may arise when transmitting display data for displaying information described in various formats from each information processing apparatus to a terminal apparatus.

### SUMMARY

According to an aspect, there is provided an information processing apparatus having a processor configured to perform a procedure including: acquiring sets of display data for displaying information from a plurality of apparatuses; converting the sets of display data acquired from the plurality of apparatuses into a single set of display data by a conversion method based on additional information added to each set of display data; and transmitting the converted set of display data to a display apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary configuration of and exemplary processing by an information processing apparatus according to a first embodiment;

FIG. 2 illustrates an exemplary configuration of a storage system according to a second embodiment;

FIG. 3 illustrates an exemplary hardware configuration of a tape library apparatus;

FIG. 4 illustrates an exemplary hardware configuration of a management terminal;

FIG. 5 illustrates an exemplary embedding of a conversion keyword for HTML data;

FIG. 6 illustrates an exemplary configuration of a processing function included in the management terminal and the tape library apparatus;

FIG. 7 illustrates an exemplary volume management table;

FIG. 8 is a block diagram illustrating an internal configuration of an HTML integrated processing unit;

FIG. 9 is a sequence chart illustrating an exemplary process flow when an HTTP request is transmitted from the management terminal to a master apparatus;

FIG. 10 is a flowchart illustrating an exemplary processing by HTML conversion processing unit;

FIG. 11 illustrates an exemplary conversion of HTML data including “Ex=COLLECT”;

FIG. 12 illustrates an exemplary display of a

Web screen corresponding to FIG. 11;

FIG. 13 is a flowchart illustrating exemplary data conversion processing when “Ex=COLLECT” is detected;

FIG. 14 illustrates an exemplary conversion of HTML data including “Ex=ONLY ONE”;

FIG. 15 illustrates an exemplary display of a Web screen corresponding to FIG. 14;

FIG. 16 is a flowchart illustrating exemplary data conversion processing when “Ex=ONLY ONE” is detected;

FIG. 17 illustrates an exemplary display of a form screen;

FIG. 18 illustrates an exemplary conversion of HTML data including “Ex=SUBMIT”;

FIG. 19 is a flowchart illustrating exemplary data conversion processing when “Ex=SUBMIT” is detected; and

FIG. 20 is a sequence chart illustrating an exemplary process flow when an HTTP request is transmitted according to a submit operation.

### DESCRIPTION OF EMBODIMENTS

Several embodiments will be described below with reference to the accompanying drawings, wherein like reference numerals refer to like elements throughout.

### First Embodiment

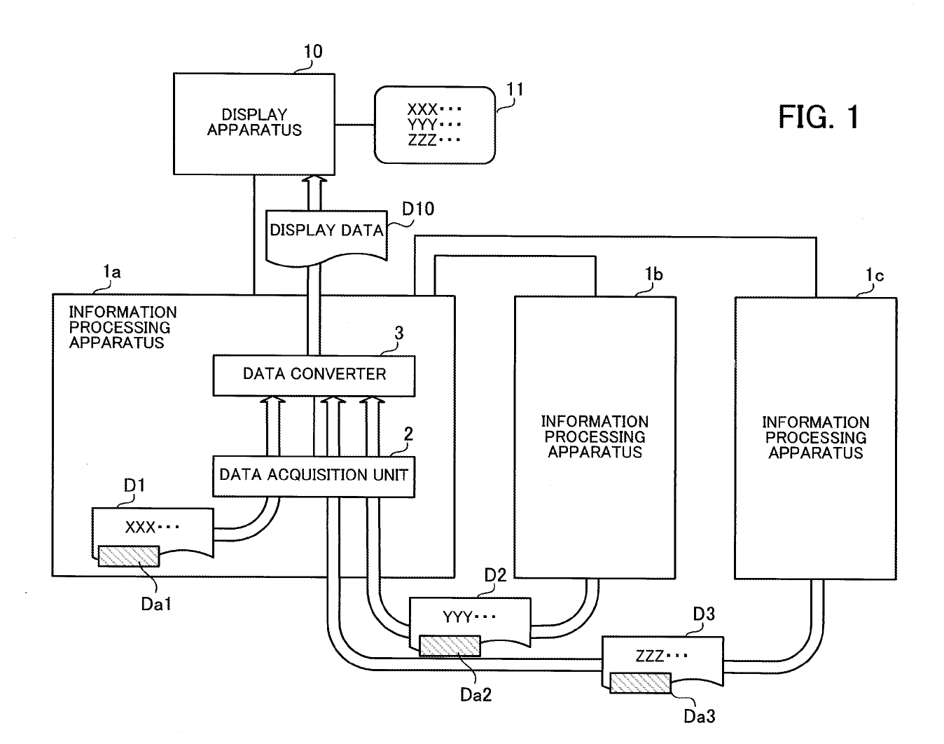

FIG. 1 illustrates an exemplary configuration and exemplary processing by an information processing apparatus according to a first embodiment. An information processing apparatus 1a has a data acquisition unit 2 and a data converter 3. Processing by the data acquisition unit 2 and the data converter 3 is realized by, for example, executing a predetermined program by a processor provided in an information processing apparatus 1a.

The data acquisition unit 2 acquires sets of display data for displaying information from a plurality of apparatuses. The data converter 3 converts the sets of display data acquired from the plurality of apparatuses into a single set of display data by a conversion method based on additional information added to each set of display data, and transmits the converted set of display data to a display apparatus 10. Accordingly, it is possible to display information acquired from a plurality of apparatuses collectively on a display screen 11 of the display apparatus 10.

In FIG. 1, the data acquisition unit 2 acquires, for example, sets of display data D1, D2 and D3 respectively from the information processing apparatus 1a and other information processing apparatuses 1b and 1c connected to the information processing apparatus 1a. For example, let us assume that the set of display data D1 is data for displaying information “XXX . . . ”, the set of display data D2 is data for displaying information “YYY . . . ”, and the display data set D3 is data for displaying information “ZZZ . . . ”.

The sets of display data D1, D2 and D3 are acquired in the following manner, for example. Upon receiving a processing request from the display apparatus 10, the information processing apparatus 1a distributes the received processing request to the information processing apparatuses 1a, 1b and 1c.

The information processing apparatus 1b performs a procedure according to the distributed processing request, acquires “YYY . . . ” as the processing result, and returns the set of display data D2 for displaying “YYY . . . ” to the information processing apparatus 1a. The information processing apparatus 1c similarly performs a procedure according to the distributed processing request, acquires “ZZZ . . . ” as the processing result, and returns the set of display data D3 for displaying “ZZZ . . . ” to the information processing apparatus 1a. In addition, the information processing apparatus 1a performs a procedure according to the distributed processing request, acquires “XXX . . . ” as the processing result, and outputs the set of display data D1 for displaying “XXX . . . ”. Accordingly, the sets of display data D1, D2 and D3 are acquired.

The sets of display data D1, D2 and D3 have pieces of additional information Da1, Da2 and Da3 respectively added thereto. The pieces of additional information Da1, Da2 and Da3 are pieces of information indicating the conversion method when converting a plurality of sets of display data into a single set of display data. The data converter 3 converts the acquired sets of display data D1, D2 and D3 into a single set of display data D10 by a conversion method based on the pieces of additional information Da1, Da2, Da3 respectively added thereto, and transmits the set of display data D10 to the display apparatus 10. The display apparatus 10 performs display processing based on the set of display data D10, and thereby “XXX . . . ”, “YYY . . . ”, “ZZZ . . . ” are collectively displayed on the display screen 11.

Here, the data converter 3 converts the sets of display data by a conversion method based on additional information, and thereby it becomes possible to perform various kinds of conversion processing according to the information to be displayed. Therefore, high-level conversion processing may be performed in comparison with, for example, a case of simply combining the sets of display data. For example, it is possible to adjust the display state of information acquired from each of the information processing apparatuses 1a, 1b and 1c, and display the acquired pieces of information on a single screen in an easy-to-view manner with useless information omitted. In addition, a viewer may also view the pieces of information relating to the plurality of information processing apparatuses 1a, 1b and 1c in a manner as if viewing a piece of information relating to a single information processing apparatus.

### Second Embodiment

Next, a storage system using a magnetic tape as the storage medium will be described as an exemplary system including the aforementioned information processing apparatus.

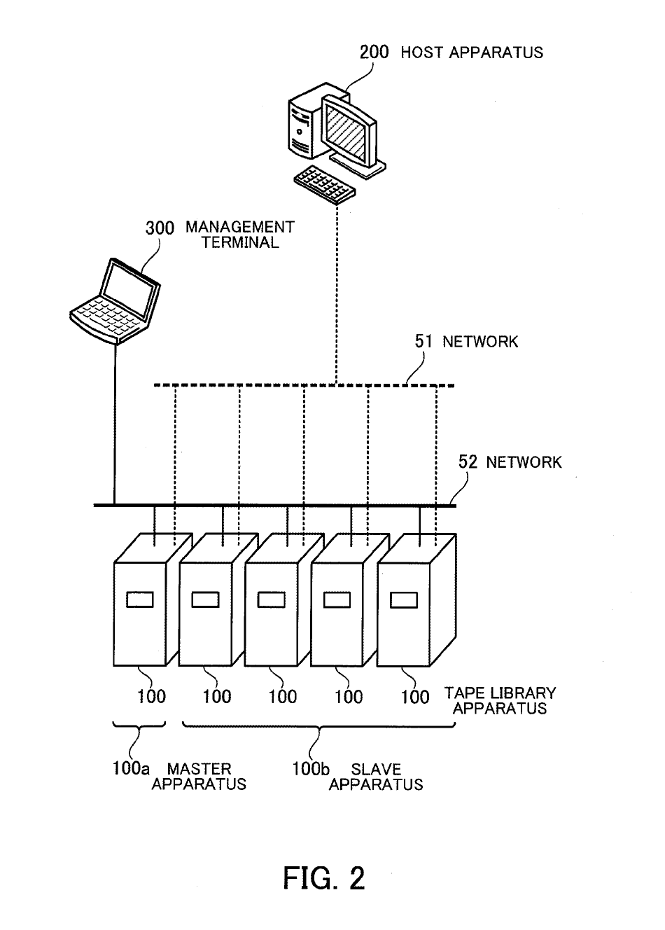

FIG. 2 illustrates an exemplary configuration of a storage system according to a second embodiment. The storage system illustrated in FIG. 2 has a plurality of tape library apparatuses 100.

Each tape library apparatus 100 has a host apparatus 200 connected thereto via a network 51. The network 51 is a FC (Fibre Channel) network, for example.

Each tape library apparatus 100 has a tape storage unit having a plurality of magnetic tapes stored therein, and one or more built-in tape drives. Using the built-in tape drive, each tape library apparatus 100 reads or writes data from or to the magnetic tape, in response to a request from the host apparatus 200. For example, upon receiving a name of a tape volume to be accessed and a read or write request from the host apparatus 200, the tape library apparatus 100 acquires, from tape storage unit, a magnetic tape corresponding to the received tape volume name, mounts the magnetic tape on the tape drive, and reads or writes data according to the request.

As thus described, each tape library apparatus 100 provides the host apparatus 200 with a storage area realized by a plurality of magnetic tapes stored therein. The plurality of tape library apparatuses 100 is coupled together for use, and thus the host apparatus 200 is provided with a large-capacity storage area based on a large number of magnetic tapes.

Each tape library apparatus 100 may have a plurality of the host apparatuses 200 connected thereto. In addition, each tape library apparatus 100 may be connected to the host apparatus 200 via a control device which performs control to use a magnetic tape in each tape library apparatus 100 as a back-end of a hierarchical storage system, for example.

In addition, the tape library apparatuses 100 are mutually connected via the network 52 used for maintenance. The network 52 is a LAN (Local Area Network), for example. The network 52 has a management terminal 300 connected thereto.

The management terminal 300 is a terminal apparatus operated by an administrator managing each tape library apparatus 100. The administrator may perform various setting operations for each tape library apparatus 100 such as browsing information of configuration or setting of each tape library apparatus 100, using the management terminal 300.

Communication is performed over the network 52 according to HTTP (HyperText Transfer Protocol). Each tape library apparatus 100 includes a Web server function. The management terminal 300, on the other hand, operates as a client which includes a Web browser function and requests processing to the Web server function of each tape library apparatus 100. The management terminal 300 has an interface screen displayed thereon to request browsing or setting of information to each tape library apparatus 100. Each tape library apparatus 100 performs a procedure according to the request transmitted from the management terminal 300 via the interface screen, and returns the processing result.

In the present embodiment, the management terminal 300 communicates with one of the plurality of tape library apparatuses 100. Among the plurality of tape library apparatuses 100, one apparatus that communicates with the management terminal 300 operates as a master apparatus, whereas the other apparatuses operate as slave apparatuses. In the following, the tape library apparatus 100 which communicates with the management terminal 300 may be referred to as a “master apparatus 100a”, and the tape library apparatus 100 which does not communicate with the management terminal 300 may be referred to as a “slave apparatus 100b”.

The master apparatus 100a collectively receives HTTP requests from the management terminal 300 to each tape library apparatus 100. When the received HTTP request is addressed to the slave apparatus 100b, the master apparatus 100a transfers the received HTTP request to the slave apparatus 100b via the network 52. The slave apparatus 100b which received the HTTP request performs a procedure according to the request, and transmits an HTTP response to the master apparatus 100a instead of the management terminal 300. The master apparatus 100a relays the HTTP response transmitted from the slave apparatus 100b and transmits the HTTP response to the management terminal 300.

In addition, upon receiving an HTTP request common to each tape library apparatus 100 from the management terminal 300, the master apparatus 100a distributes the received HTTP request to each slave apparatus 100b and to the master apparatus 100a, as described below. The master apparatus 100a may convert the sets of HTML data returned from the respective slave apparatuses 100b and from the master apparatus 100a, integrate the converted sets of HTML data into a single set of HTML data, and transmit the single set of HTML data to the management terminal 300. Accordingly, the management terminal 300 may display the pieces of information related to each tape library apparatus 100 collectively on a single screen.

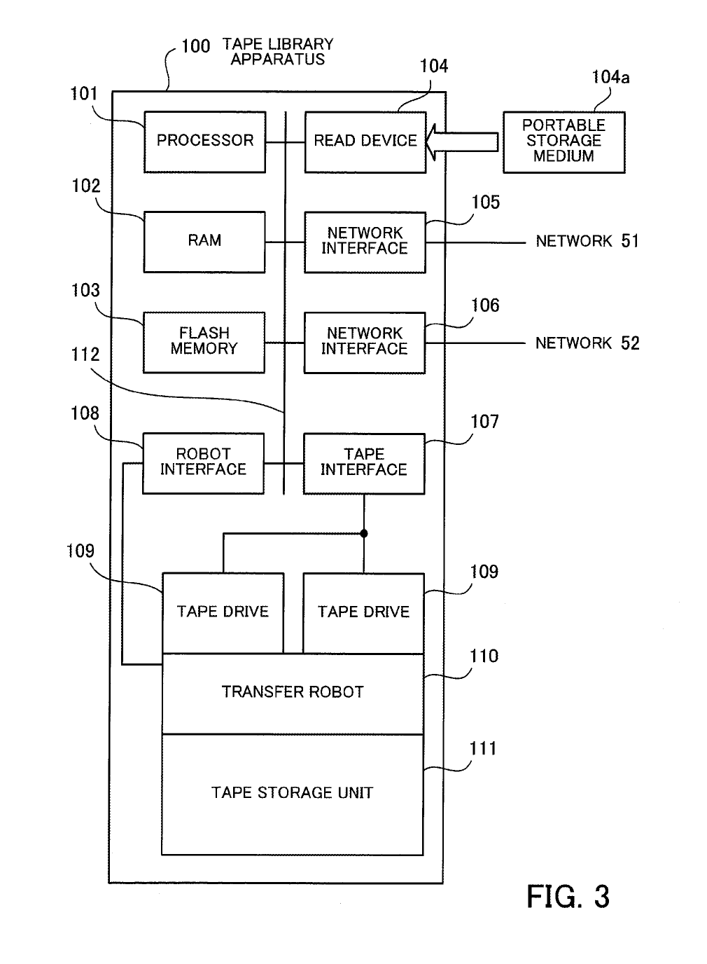

FIG. 3 illustrates an exemplary hardware configuration of a tape library apparatus. The tape library apparatus 100 has a processor 101, a RAM 102 (Random Access Memory), a flash memory 103, a read device 104, network interfaces 105 and 106, a tape interface 107, a robot interface 108, a tape drive 109, a transfer robot 110, and a tape storage unit 111.

The processor 101 controls the entire tape library apparatus 100 in a unified manner. The processor 101 is, for example, a CPU (Central Processing Unit), an MPU (Micro Processing Unit), a DSP (Digital Signal Processor), an ASIC (Application Specific Integrated Circuit), or a PLD (Programmable Logic Device). In addition, the processor 101 may be a combination of two or more elements of a CPU, an MPU, a DSP, an ASIC, and a PLD.

The processor 101 has the RAM 102 and a plurality of peripheral devices connected thereto via a bus 112.

The RAM 102 is used as the main storage device of the tape library apparatus 100. The RAM 102 temporarily stores at least a part of a program to be executed by the processor 101. In addition, the RAM 102 stores various data needed for processing by the processor 101.

The bus 112 has the flash memory 103, the read device 104, the network interfaces 105 and 106, the tape interface 107, and the robot interface 108 connected thereto as peripheral devices.

The flash memory 103 is used as a secondary storage device of the tape library apparatus 100. The flash memory 103 stores firmware programs and various data. Other types of non-volatile storage devices such as an HDD (Hard Disk Drive) may be used as the secondary storage device.

The read device 104 has a portable storage medium 104a attached thereto or detached therefrom. The read device 104 reads data stored in the portable storage medium 104a and transmits the data to the processor 101. The portable storage medium 104a may be an optical disk, a magneto-optical disk, a semiconductor memory, or the like.

The network interface 105 is a communication interface configured to transmit or receive data to and from the host apparatus 200 via the network 51. The network interface 106 is a communication interface configured to transmit or receive data to and from another tape library apparatus 100 or the management terminal 300 via the network 52.

The tape interface 107 is a communication interface configured to transmit or receive data to and from the tape drive 109. The robot interface 108 is a communication interface configured to transmit or receive data to and from the transfer robot 110.

There are one or more tape drives 109 mounted in the tape library apparatus 100. Each tape drive 109 mounts tape cartridges one by one, which have been transferred by the transfer robot 110, and under control of the processor 101, writes data to or reads data from a magnetic tape in the mounted tape cartridge.

The tape storage unit 111 stores a plurality of tape cartridges. The transfer robot 110 transfers a tape cartridge under control of the processor 101. The transfer robot 110 transfers a tape cartridge stored in the tape storage unit 111, for example, to one of the tape drives 109 and mounts the tape cartridge thereon. In addition, the transfer robot 110 unmounts a tape cartridge from the tape drive 109, transfers the tape cartridge to the tape storage unit 111, and stores the tape cartridge therein.

The processing function of the tape library apparatus 100 may be realized with the aforementioned hardware configuration.

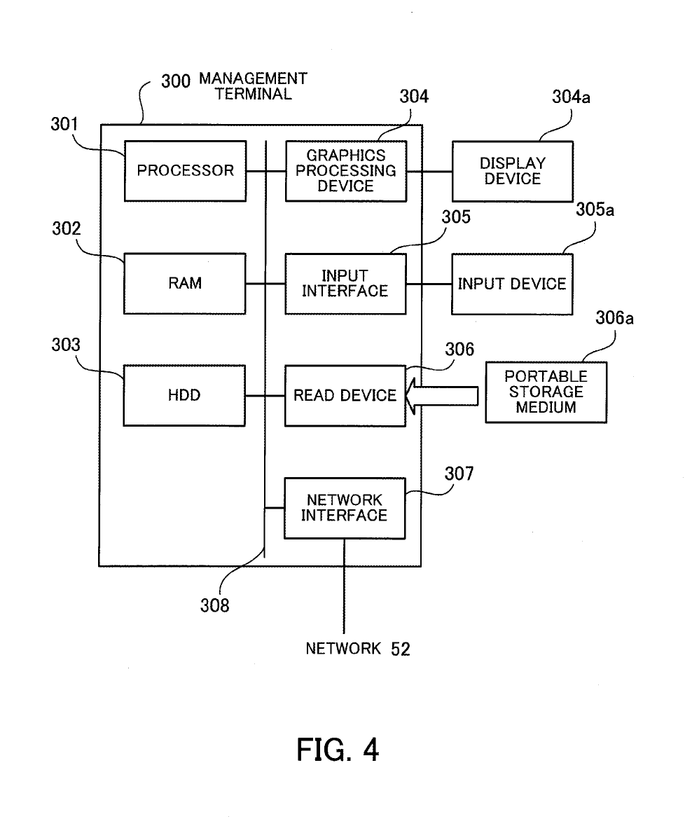

FIG. 4 illustrates an exemplary hardware configuration of a management terminal. The management terminal 300 is realized as a computer illustrated in FIG. 4, for example.

The management terminal 300 is controlled as a whole by a processor 301. The processor 301 may be a multiprocessor. The processor 301 is, for example, a CPU, an MPU, a DSP, an ASIC or a PLD, similarly to the processor 101 described above. In addition, the processor 301 may be a combination of two or more elements of a CPU, an MPU, a DSP, an ASIC, and a PLD.

The processor 301 has a RAM 302 and a plurality of peripheral devices connected thereto via a bus 308.

The RAM 302 is used as the main storage device of the management terminal 300. The RAM 302 temporarily stores at least a part of the OS (Operating System) program or application programs to be executed by the processor 301. In addition, the RAM 302 stores various data needed for processing by the processor 301.

An HDD 303, a graphics processing device 304, an input interface 305, a read device 306, and a network interface 307 may be provided as peripheral devices connected to the bus 308.

The HDD 303 is used as an auxiliary storage device of the management terminal 300. The HDD 303 has the OS program, application programs, and various data stored therein. Other types of non-volatile storages such as an SSD (Solid State Drive) may be used as the auxiliary storage device.

The graphics processing device 304 has a display device 304a connected thereto. The graphics processing device 304 displays images on the screen of the display device 304a according to an instruction from the processor 301. A display device using a CRT (Cathode Ray Tube) or a liquid crystal display device may be used as the display device 304a.

The input interface 305 has an input device 305a connected thereto. The input interface 305 transmits a signal output from the input device 305a to the processor 301. A keyboard, a pointing device or the like may be used as the input device 305a. The pointing device may be a mouse, a touch panel, a tablet, a touchpad, a track ball, or the like.

The read device 306 has a portable storage medium 306a attached thereto or detached therefrom. The read device 306 reads data stored in the portable storage medium 306a and transmits the data to the processor 301. The portable storage medium 306a may be an optical disk, a magneto-optical disk, a semiconductor memory, or the like.

The network interface 307 transmits or receives data to and from the master apparatus 100a via the network 52.

The processing function of the management terminal 300 may be realized with the aforementioned hardware configuration.

Next, the processing performed between the management terminal 300 and each tape library apparatus 100 will be described. First, a reference example of a communication method between the management terminal and a plurality of tape library apparatuses is described, which is followed by description of the processing of the present embodiment.

For example, the following may be considered as a communication method between a management terminal and a plurality of tape library apparatuses.

### REFERENCE EXAMPLE 1

A method in which the management terminal directly accesses each of the plurality of tape library apparatuses.

### REFERENCE EXAMPLE 2

A method in which the management terminal accesses one of the plurality of tape library apparatuses (master apparatus).

In the case of the reference example 1, the administrator specifies the address of the access destination apparatus so that an HTTP request is transmitted to a desired tape library apparatus from the management terminal. The tape library apparatus which has received the HTTP request executes a CGI (Common Gateway Interface) program specified by the received HTTP request, and transmits an HTTP response to the management terminal. Such processing causes the management terminal to display information for each access destination tape library apparatus.

In the case of the reference example 2, the processing by the master apparatus may improve the administrator's operability. For example, the master apparatus causes the management terminal to display the top screen on which the access destination apparatus may be easily specified by a pull down menu or the like. When an access destination apparatus is specified on the top screen, the master apparatus transmits an HTTP request to the specified apparatus by executing a CGI program for processing the top screen. The master apparatus then transfers the HTTP response from the transmission destination device of the HTTP request to the management terminal, and displays information related to the apparatus on a predetermined frame position on the top screen, for example.

Here, with both the reference examples 1 and 2, the management terminal displays information individually for each tape library apparatus to the end. Accordingly, the administrator is not able to display in a list, on a single screen, pieces of information relating to the plurality of information processing apparatuses, and to browse them at a time. Additionally, in order to acquire information related to a plurality of tape library apparatuses, the administrator has to perform an operation to acquire information for each tape library apparatus.

In addition, there is conceivable a method of combining, in the master apparatus, the sets of HTML data returned from respective tape library apparatuses and transferring the combined sets of HTML data to the management terminal as a method of displaying information related to a plurality of tape library apparatuses on the screen of the management terminal at a time. With this method, however, display information based on each of the returned sets of HTML data is simply displayed in a row on the screen of the management terminal, which is not a display state to be easily browsed by the administrator.

In the present embodiment, therefore, the master apparatus 100a causes, in response to a single request from the management terminal 300, all the tape library apparatuses 100 to perform processing according to the request. The present embodiment then causes the master apparatus 100a to convert the sets of HTML data returned by execution of the processing into a single set of HTML data, and transmit the converted set of HTML data to the management terminal 300. Accordingly, it becomes possible to display information related to a plurality of tape library apparatuses on the screen of the management terminal 300 at a time by a simple operation.

In addition, the set of HTML data returned from each tape library apparatus 100 has a conversion keyword embedded therein in a form that does not affect the display processing in the Web browser. The master apparatus 100a converts the description within a predetermined range of each HTML data by a predetermined method based on the conversion keyword embedded in the set of HTML data, integrates the converted description into a single set of HTML data, and transmits the integrated set of HTML data to the management terminal 300. Accordingly, it becomes possible to perform high-level conversion processing when integrating sets of HTML data. For example, it becomes possible to adjust the display state when displaying information related to a plurality of tape library apparatuses and display information desired by the administrator without waste.

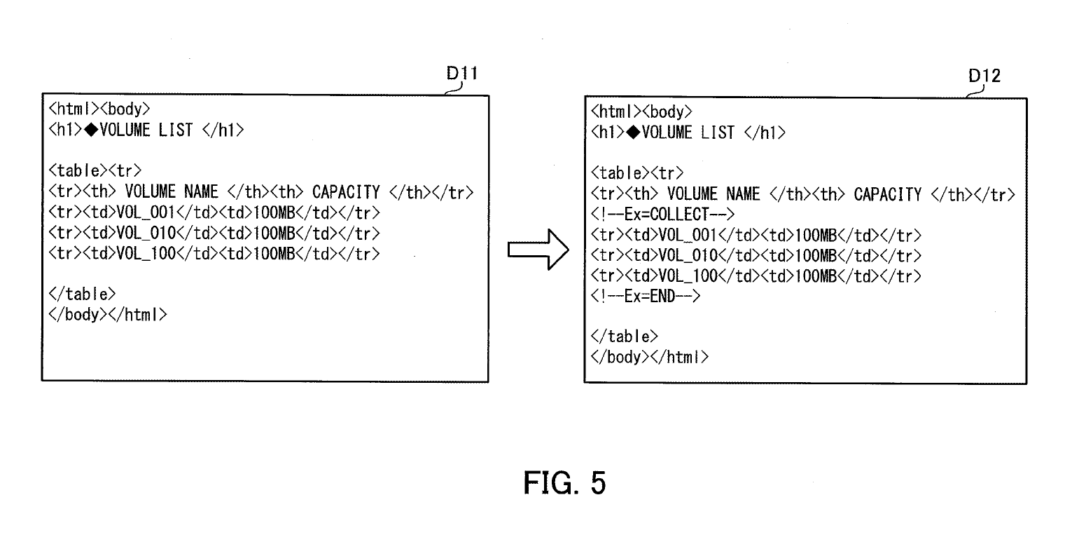

FIG. 5 illustrates exemplary embedding of a conversion keyword for HTML data. The HTML data D12 illustrated on the right side of FIG. 5 has comments “<!-Ex=COLLECT->” and “<!-Ex=END->” added to the HTML data D11 illustrated on the left side. Here, “Ex=COLLECT” and “Ex=END” in the respective comments correspond to the conversion keywords.

“Ex=END” in the HTML data D12 indicates the end of the conversion range. The master apparatus 100a converts the HTML data within the range from the position of “<!-Ex=COLLECT->” to the position of “<!-Ex=END->” using a conversion method indicated by “Ex=COLLECT”. In other words, the method and range of converting the HTML data are specified by the conversion keyword.

In addition, the conversion keyword is embedded in the HTML data in a form of a “comment” which does not affect the display processing in the Web browser as described above. Therefore, even when HTML data with a conversion keyword embedded therein is transmitted, as is, to the management terminal 300, for example, the management terminal 300 may normally display a document based on the HTML data.

Each tape library apparatus 100 preliminarily stores a template for creating HTML data to be returned to the client side. Such a template is prepared for each request from the client side. In the present embodiment, conversion keywords are preliminarily embedded in needed ones of the templates.

Embedding a conversion keyword in the form of a comment as described above allows each tape library apparatus 100 to commonly use a template having a conversion keyword embedded therein, both in a state where a plurality of tape library apparatuses 100 is connected for use as illustrated in FIG. 2, and in a state where the tape library apparatus 100 is used stand-alone (i.e., in a state of being directly accessed from the management terminal 300 as illustrated in the aforementioned reference example 1).

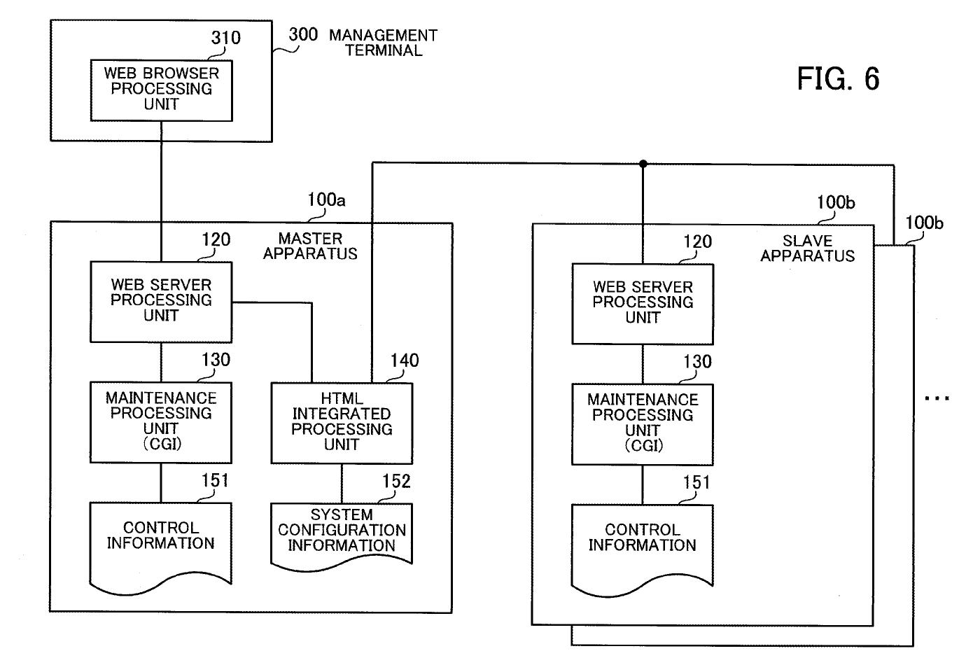

FIG. 6 illustrates an exemplary configuration of the processing function included in the management terminal and the tape library apparatus.

The management terminal 300 has a Web browser processing unit 310. The processing by the Web browser processing unit 310 is realized by executing a predetermined program by the processor 301 of the management terminal 300, for example.

The Web browser processing unit 310 displays, on the display device 304a of the management terminal 300, a GUI (Graphical User Interface) screen based on the HTML data transmitted from the Web server. In addition, the Web browser processing unit 310 transmits, to the Web server, an HTTP request according to the operation input on the GUI screen and displays, on the display device 304a, an image based on the HTML data returned from the Web server. In the following, an image displayed based on the HTML data may be referred to as a “Web image”.

The tape library apparatus 100, on the other hand, has a Web server processing unit 120, a maintenance processing unit 130, and an HTML integrated processing unit 140. Processing by the Web server processing unit 120, the maintenance processing unit 130, and the HTML integrated processing unit 140 is realized by executing predetermined programs by the processor 101 of the tape library apparatus 100, for example.

In addition, the storage device of each tape library apparatus 100 stores control information 151 and system configuration information 152. The control information 151 and the system configuration information 152 are stored in the flash memory 103 of the tape library apparatus 100, for example.

The HTML integrated processing unit 140 is activated only when the tape library apparatus 100 operates as the master apparatus 100a. In addition, the system configuration information 152 is referred to by the HTML integrated processing unit 140 only when the tape library apparatus 100 operates as the master apparatus 100a. Accordingly, in FIG. 6, the HTML integrated processing unit 140 and the system configuration information 152 are illustrated only in the master apparatus 100a but not in the slave apparatus 100b.

The Web server processing unit 120 is a process block which realizes the basic function as the Web server. The basic function as the Web server is a function of receiving an HTTP request from a client and returning HTML data according to the request to the client.

Although not illustrated, the storage device of each tape library apparatus 100 stores a template for creating HTML data to be returned to the client for each corresponding request. In addition, some of the templates have the aforementioned conversion keyword written therein. In the present embodiment, as for templates having at least a conversion keyword written therein, templates common to all the tape library apparatuses 100 are stored and used, regardless of the master apparatus 100a or the slave apparatus 100b.

In addition, the basic function as the Web server also includes a function of executing a CGI program specified by a URL (Uniform Resource Locator) included in the received HTTP request, and returning the HTML data including execution result of the CGI program to the client. In the present embodiment, a CGI program which realizes the processing by the maintenance processing unit 130 is specified and executed according to the HTTP request received by the Web server processing unit 120.

The maintenance processing unit 130 performs a procedure related to maintenance of the tape library apparatus 100, according to a request from a client. As the processing related to maintenance, there may be processing to collect information of configuration or setting of the tape library apparatus 100 requested from the client for display on the screen, processing to perform various settings requested from the client, or the like.

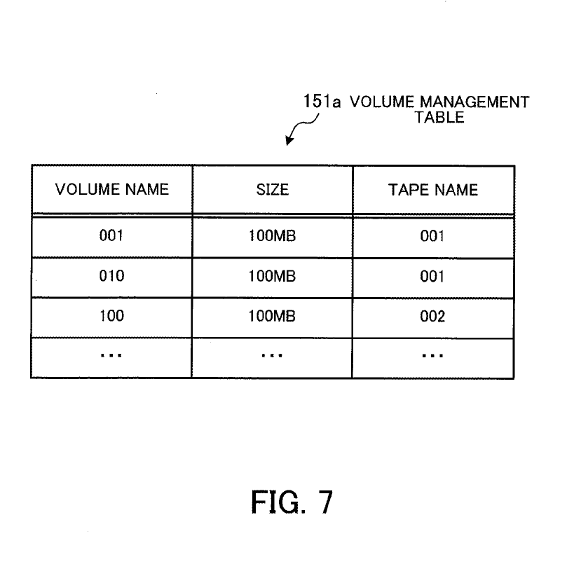

The control information 151 indicates a device whose information is to be collected, or a device to which information is to be set by the maintenance processing unit 130. As a representative example of the control information 151, there is information for controlling access to a magnetic tape according to a request from the host apparatus 200. In FIG. 7, a volume management table is taken as an example of information for controlling access to a magnetic tape.

FIG. 7 illustrates an exemplary volume management table. A volume management table 151a is table information for managing a logical volume, and has respective columns for volume name, size, and tape name. The volume-name column has the ID number of a logical volume registered therein. The size column has the size of a corresponding logical volume registered therein. The tape-name column has registered therein the ID number of a magnetic tape storing data of a corresponding logical volume.

Referring to the aforementioned volume management table 151a, the maintenance processing unit 130 may perform processing such as, for example, collecting sizes of respective logical volumes to generate list information of sizes, extracting logical volumes equal to or larger than a predetermined size, and extracting a list of magnetic tapes storing data of logical volumes and a list of logical volumes stored in each magnetic tape.

There are, as other examples of the control information 151, information related to the configuration of a device built in or externally attached to the tape library apparatus 100, information indicating the status of each device, or the like.

In the following, the description continues referring to FIG. 6 again.

Processing by the maintenance processing unit 130 and processing of the basic function as the Web server by the Web server processing unit 120 are performed in all the tape library apparatuses 100 regardless of whether they are operating as the master apparatus 100a or the slave apparatus 100b. In addition, the Web server processing unit 120 performs the following processing according to the description format of the URL included in an HTTP request.

The Web server processing unit 120 operates its “home apparatus” (the apparatus to which it belongs) as the master apparatus 100a when a host name is written in the URL included in an HTTP request addressed to its home apparatus. In the master apparatus 100a, the HTML integrated processing unit 140 is activated.

When, on the other hand, an IP (Internet Protocol) address is written in the URL included in the HTTP request addressed to its home apparatus, the Web server processing unit 120 operates its home apparatus as the slave apparatus 100b. In this case, it turns out that, as will be described below, the received HTTP request has been transmitted from another tape library apparatus 100 operating as the master apparatus 100a. In other words, a transmission destination in the URL is specified by the IP address in the communication between the master apparatus 100a and the slave apparatus 100b via the network 52.

For example, the network connecting the master apparatus 100a and the slave apparatus 100b may be physically separated from the network connecting the master apparatus 100a and the management terminal 300. In this case, the Web server processing unit 120 may determine either to operate its home apparatus as the master apparatus 100a or as the slave apparatus 100b, depending on from which network the HTTP request has been received, for example.

The Web server processing unit 120 of the master apparatus 100a outputs the received URL to the HTML integrated processing unit 140, and starts processing by the HTML integrated processing unit 140. The HTML integrated processing unit 140 operates as a virtual client, and distributes the HTTP request to the Web server processing unit 120 of each slave apparatus 100b and the Web server processing unit 120 of the master apparatus 100a itself.

Upon receiving an HTTP request from the master apparatus 100a, the Web server processing unit 120 of the slave apparatus 100b causes the maintenance processing unit 130 to perform the requested processing. The Web server processing unit 120 of the slave apparatus 100b then creates HTML data including the processing result and returns the HTML data to the master apparatus 100a. In other words, the Web server processing unit 120 of the slave apparatus 100b recognizes the master apparatus 100a as a virtual client, and performs only the aforementioned basic function as the Web server.

In the master apparatus 100a, on the other hand, an HTTP request which has been output from the HTML integrated processing unit 140 and addressed to its home apparatus is received by the Web server processing unit 120. The Web server processing unit 120 of the master apparatus 100a causes the maintenance processing unit 130 to perform processing according to the HTTP request from the HTML integrated processing unit 140, creates HTML data including the processing result, and returns the HTML data to the HTML integrated processing unit 140. In other words, the Web server processing unit 120 of the master apparatus 100a recognizes the HTML integrated processing unit 140 as a virtual client and performs only the aforementioned basic function as the Web server.

The HTML integrated processing unit 140 converts the sets of HTML data returned from each slave apparatus 100b and the Web server processing unit 120 of the master apparatus 100a into a single set of HTML data, based on the conversion keywords described in the sets of HTML data. The HTML integrated processing unit 140 outputs the converted single set of HTML data to the Web server processing unit 120, and the Web server processing unit 120 transmits the set of HTML data to the management terminal 300 as an HTTP response. Accordingly, the Web browser processing unit 310 of the management terminal 300 may aggregate and display, on a single screen, the processing results in the respective tape library apparatuses 100.

The HTML integrated processing unit 140, when distributing the HTTP request to each slave apparatus 100b and to the master apparatus 100a, recognizes each apparatus to which the HTTP request is distributed by referring to the system configuration information 152. The system configuration information 152 has registered therein IP addresses of respective slave apparatuses 100b connected to the master apparatus 100a. The IP addresses are collected from the respective slave apparatuses 100b and registered immediately after the master apparatus 100a is powered on, for example.

As described above, the HTTP request transmitted from the management terminal 300 to the master apparatus 100a has the host name written in the URL. The HTML integrated processing unit 140 rewrites the host name of the URL included in the HTTP request received from the management terminal 300 to the IP address of each apparatus of a distribution destination, based on the system configuration information 152, and transmits the rewritten HTTP request to the network 52.

Accordingly, the same processing is requested to each tape library apparatus 100, according to a one-time HTTP request from the management terminal 300. At the same time, the slave apparatus 100b recognizes that the request is an HTTP request from the master apparatus 100a, and is allowed to operate as the slave apparatus 100b.

Furthermore, each tape library apparatus 100 is allowed to operate in a stand-alone manner (i.e., directly accessed from the management terminal 300) by receiving an HTTP request including a URL having an IP address written therein. In other words, the tape library apparatus 100 performs the same processing for the cases of: operating as the slave apparatus 100b; directly receiving an HTTP request from the management terminal 300; and receiving an HTTP request from a client virtually realized by the HTML integrated processing unit 140 of the master apparatus 100a. Accordingly, it becomes possible to couple together the plurality of tape library apparatuses 100 and operate them, or operate the tape library apparatuses 100 in a stand-alone manner, without changing the program to be implemented in the tape library apparatus 100, whereby man-hour for program development and device production cost may be reduced.

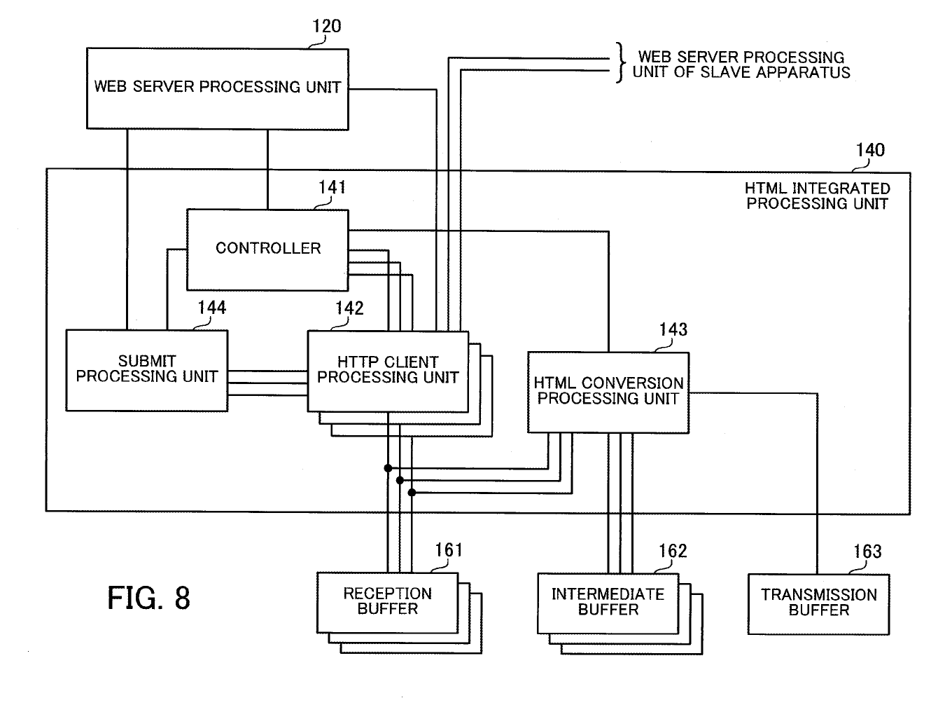

FIG. 8 is a block diagram illustrating the internal configuration of the HTML integrated processing unit. The HTML integrated processing unit 140 has a controller 141, a plurality of HTTP client processing unit 142, an HTML conversion processing unit 143, and a submit processing unit 144. Processing by the submit processing unit 144 is realized by a predetermined CGI program.

In addition, the HTML integrated processing unit 140 reserves a plurality of reception buffers 161, a plurality of intermediate buffers 162, and a transmission buffer 163 in the storage area of the RAM 102. There are reserved as many reception buffers 161 and intermediate buffers 162, respectively, as the number of tape library apparatuses 100 coupled together.

Upon receiving, from the Web server processing unit 120, the URL received from the management terminal 300, the controller 141 activates the HTTP client processing unit 142. There are as many HTTP client processing units 142 activated as the number of tape library apparatuses 100, and the controller 141 passes the received URL and the IP address of each tape library apparatus 100 to each HTTP client processing unit 142.

The HTTP client processing unit 142 operates as a virtual client for a corresponding tape library apparatus 100. The HTTP client processing unit 142 rewrites the host name in the received URL to the IP address passed from the controller 141, and outputs an HTTP request including the rewritten URL to the corresponding tape library apparatus 100.

Here, when the corresponding tape library apparatus 100 is other than its home apparatus, namely is the slave apparatus 100b, the HTTP request is transmitted to the corresponding slave apparatus 100b and received by the Web server processing unit 120 of the transmission destination slave apparatus 100b. When, on the other hand, the corresponding tape library apparatus 100 is its home apparatus, the HTTP request is output to the Web server processing unit 120 of its home apparatus, namely the master apparatus 100a.

The HTTP client processing unit 142 stores the HTML data returned from the output destination Web server processing unit 120 respectively in the reception buffers 161 corresponding to the output destination apparatuses. Upon completion of storing the HTML data by each HTTP client processing unit 142, the controller 141 causes the HTML conversion processing unit 143 to perform conversion processing of the HTML data.

The HTML conversion processing unit 143 reads sets of HTML data stored in the reception buffers 161, converts the sets of HTML data of respective reception buffers 161 into a single set of HTML data by a conversion method according to the conversion message described therein, and stores the converted single set of HTML data in the transmission buffer 163.

In addition, the HTML conversion processing unit 143 uses the intermediate buffers 162 in the course of conversion. For example, the HTML conversion processing unit 143 temporarily stores a part of the HTML data read from one of the reception buffers 161 to one of the intermediate buffers 162 corresponding to the same apparatus.

Upon accepting a submit operation by the Web browser processing unit 310 of the management terminal 300, the submit processing unit 144 is activated by the Web server processing unit 120. Specifically, when a submit operation is performed and the content of input to the form is transmitted, the Web server processing unit 120 executes the CGI program written in the received URL. Thereby, the submit processing unit 144 is activated.

The submit processing unit 144 converts the name of the CGI program written in the received URL. Although the details will be described below, the converted name of the CGI program is the name of the CGI program in the HTML data which has been output from each tape library apparatus 100 in order to display the form screen, and which had been written before conversion by the HTML conversion processing unit 143.

The submit processing unit 144 activates as many HTTP client processing units 142 as the number of tape library apparatuses 100, and passes the URL with the converted program name and the IP address of each tape library apparatus 100 to each HTTP client processing unit 142.

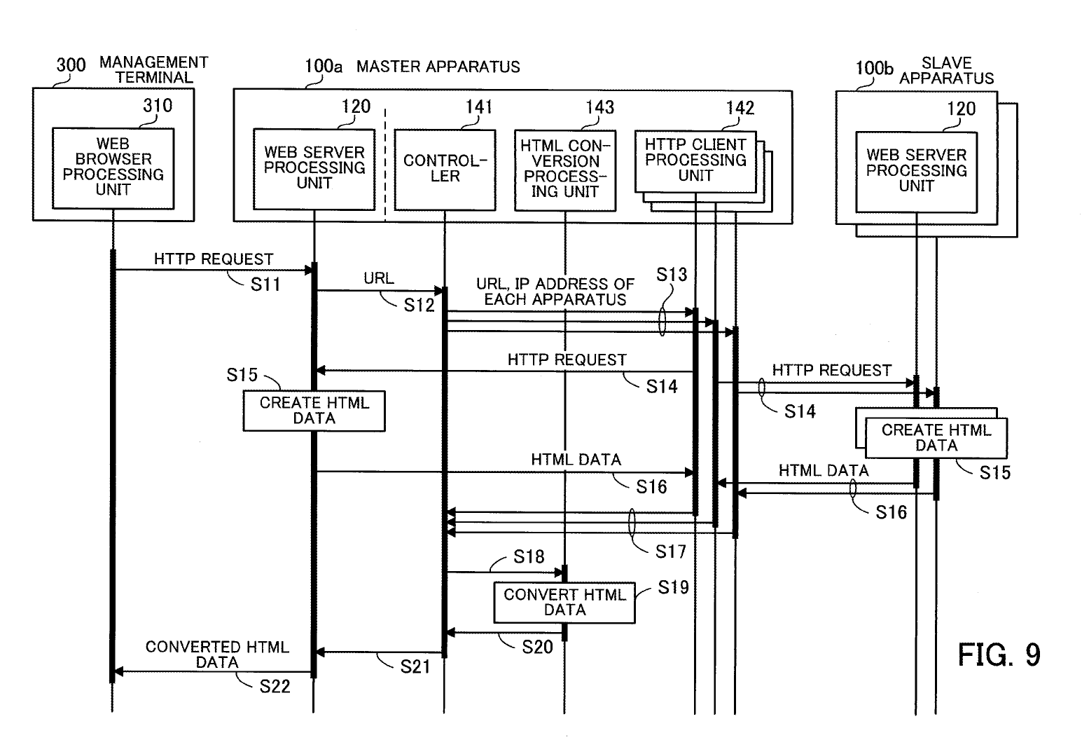

Next, FIG. 9 is a sequence chart illustrating an exemplary process flow when an HTTP request is transmitted from the management terminal to the master apparatus. It is assumed in FIG. 9 that two slave apparatuses 100b are connected to the master apparatus 100a, as an example.

The Web browser processing unit 310 of the management terminal 300 transmits an HTTP request according to an input operation by the administrator (step S11). On this occasion, the URL has the host name of one of the tape library apparatuses 100 (i.e., the master apparatus 100a) specified therein.

The Web server processing unit 120 of the master apparatus 100a receives an HTTP request addressed to the master apparatus 100a from the management terminal 300. On this occasion, the Web server processing unit 120 determines to operate its home apparatus as the master apparatus 100a since the host name of its home apparatus is written in the URL. Based on the determination, the Web server processing unit 120 of the master apparatus 100a notifies the controller 141 of the HTML integrated processing unit 140 of the URL included in the received HTTP request as a processing parameter (step S12).

The controller 141 activates as many HTTP client processing units 142 as the number of apparatuses registered in the system configuration information 152 i.e., the number of the tape library apparatuses 100 including its home apparatus. Accordingly, execution of an individual HTTP client process is activated for each of the tape library apparatuses 100. On this occasion, the controller 141 transfers the URL notified from the Web server processing unit 120 to each of the activated HTTP client processing units 142. At the same time, the controller 141 notifies each of the activated HTTP client processing units 142 of IP addresses which are different from each other, out of the IP addresses of respective apparatuses registered in the system configuration information 152 (step S13).

Each HTTP client processing unit 142 operates as a virtual client which issues a request to the corresponding tape library apparatus 100. Specifically, each HTTP client processing unit 142 rewrites the host name in the URL notified from the controller 141 to an IP address of the corresponding apparatus which has been notified from the controller 141. Each HTTP client processing unit 142 then outputs an HTTP request including the rewritten URL to the Web server processing unit 120 of a corresponding apparatus (step S14). When the corresponding apparatus is another tape library apparatus 100, i.e., the slave apparatus 100b, the HTTP request is transmitted to the Web server processing unit 120 of the corresponding slave apparatus 100b via the network 52. In addition, when the corresponding apparatus is its home apparatus, the HTTP request is notified to the Web server processing unit 120 of its home apparatus, namely the master apparatus 100a.

The Web server processing unit 120 of the slave apparatus 100b, since the IP address of its home apparatus is written in the URL included in the HTTP request addressed to its home apparatus, determines to operate its home apparatus as the slave apparatus 100b. In this case, the Web server processing unit 120 of each slave apparatus 100b causes the maintenance processing unit 130 of its home apparatus to perform the requested processing, and creates HTML data having the processing result described therein (step S15). In addition, the Web server processing unit 120 of the master apparatus 100a similarly causes the maintenance processing unit 130 of its home apparatus to perform the requested processing, and creates HTML data having the processing result described therein (step S15).

The HTTP requests output to respective tape library apparatuses 100 at step S14 request the same processing. Accordingly, at step S15, the templates used by the Web server processing units 120 of the respective tape library apparatuses 100 to create HTML data are the same. In addition, these templates have the same conversion keyword written at the same position.

The Web server processing unit 120 of each tape library apparatus 100 outputs the created HTML data to the corresponding HTTP client processing unit 142 in the master apparatus 100a (step S16). The HTML data created by the Web server processing unit 120 of the slave apparatus 100b is transmitted, via the network 52, to the corresponding HTTP client processing unit 142 of the master apparatus 100a. In addition, the HTML data created by the Web server processing unit 120 of the master apparatus 100a is notified to the corresponding HTTP client processing unit 142 of the master apparatus 100a.

Each HTTP client processing unit 142 of the master apparatus 100a stores the received HTML data in the corresponding reception buffer 161, and notifies the controller 141 of completion of processing (step S17). Upon receiving the notice of completion of processing from all the activated HTTP client processing units 142, the controller 141 activates the HTML conversion processing unit 143 (step S18).

The HTML conversion processing unit 143 refers to the sets of HTML data stored in the reception buffers 161 and, based on the conversion keywords described in the sets of HTML data, converts the sets of HTML data and integrates them into a single set of HTML data (step S19). During the processing, the HTML conversion processing unit 143 uses the intermediate buffers 162 as appropriate. Finally, the HTML conversion processing unit 143 stores the converted single set of HTML data in the transmission buffer 163, and notifies the controller 141 of completion of processing (step S20).

The controller 141 notifies the Web server processing unit 120 of completion of the series of processing (step S21). The Web server processing unit 120 reads the converted HTML data from the transmission buffer 163 and transmits it to the management terminal 300 (step S22). The Web browser processing unit 310 of the management terminal 300 displays, on the display device 304a, a Web image based on the received HTML data. On this occasion, the results of processing in respective tape library apparatuses 100 are displayed on a single Web screen in an aggregated manner.

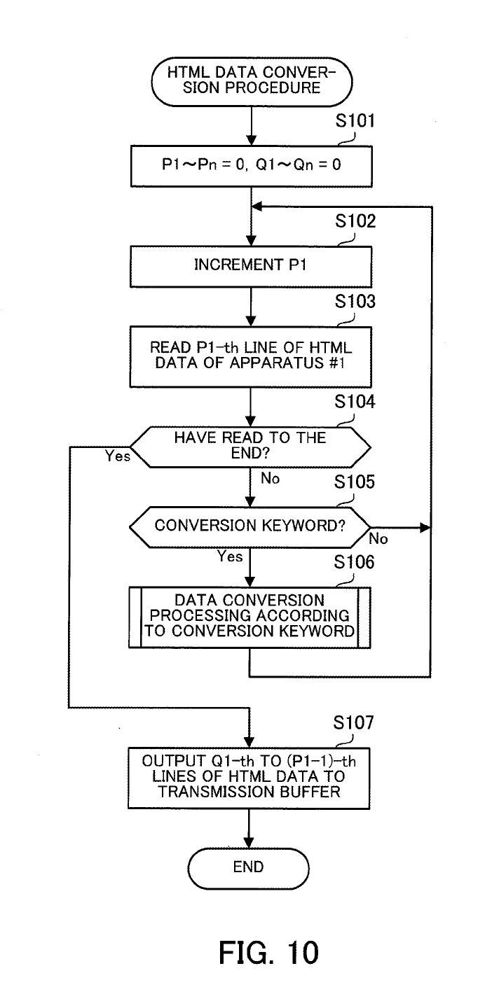

Next, processing by the HTML conversion processing unit 143 of the HTML integrated processing unit 140 will be described. FIG. 10 is a flowchart illustrating exemplary processing by the HTML conversion processing unit. The processing of FIG. 10 corresponds to the process of step S19 of FIG. 9.

[Step S101] The HTML conversion processing unit 143 initializes pointers P1 to Pn and Q1 to Qn to be used in the following processing to “0”.

Here, each of the pointers P1 to Pn corresponds to an apparatus which is the transmission source of HTML data. In addition, each of the pointers Q1 to Qn similarly corresponds to an apparatus which is the transmission source of HTML data. In other words, the upper limit of n is equivalent to the number of the tape library apparatuses 100.

The pointers P1 to Pn indicate the line numbers of the lines to be read (to be referred to) in the lines of HTML data of the corresponding apparatus. In addition, the pointers Q1 to Qn are used to hold the first line of the HTML data of the corresponding apparatus in the range to be output to the buffer.

The subscripts “1” to “n” indicate the ID numbers individually provided to the tape library apparatuses 100, and the HTML conversion processing unit 143 may arbitrarily determine which apparatus is provided with which ID number.

Additionally, in the following description, the pointers P1 to Pn and the pointers Q1 to Qn may be denoted as “pointer P” and “pointer Q”, respectively, when it is not particularly specified which pointer corresponds to which apparatus. Furthermore, in the following description, each tape library apparatus 100 may be provided with an ID number x and denoted as “apparatus #x”. For example, the pointers P and Q corresponding to an apparatus #1 are the pointers P1 and Q1, respectively.

[Step S102] The HTML conversion processing unit 143 increments the pointer P1 of the apparatus #1 by “1”.

[Step S103] The HTML conversion processing unit 143 reads the P1-th line of the HTML data of the apparatus #1. The HTML data of the apparatus #1 is stored in the reception buffer 161 corresponding to the apparatus #1.

[Step S104] The HTML conversion processing unit 143 determines whether there is no line indicated by the pointer P1, in other words, whether the HTML data has already been read to the end. When the reading has been completed, the process of step S107 is performed, whereas the process of step S105 is performed when the reading has not been completed.

[Step S105] The HTML conversion processing unit 143 determines whether the content read at step S103 is a conversion keyword. When the content is a conversion keyword, the process of step S106 is performed, whereas the process flow returns to the process of step S102 when it is not a conversion keyword.

[Step S106] The HTML conversion processing unit 143 performs conversion processing of the HTML data according to the read conversion keyword. Details of the conversion processing will be described below. After completion of the conversion processing, the process flow returns to the process of step S102.

[Step S107] The HTML conversion processing unit 143 outputs, from the reception buffer 161 corresponding to the apparatus #1 to the transmission buffer 163, data ranging from the line indicated by the pointer Q1 to the line bearing a number smaller than the value of the pointer P1 by “1” in the HTML data of the apparatus #1.

Next, referring to a specific example of a conversion keyword, exemplary conversion processing of HTML data according to the conversion keyword will be described. As described above, the conversion keyword is written in the comment like “Ex= . . . ”. In addition, “Ex=END” indicates the end of the conversion range.

First, the conversion keyword “Ex=COLLECT” will be described.

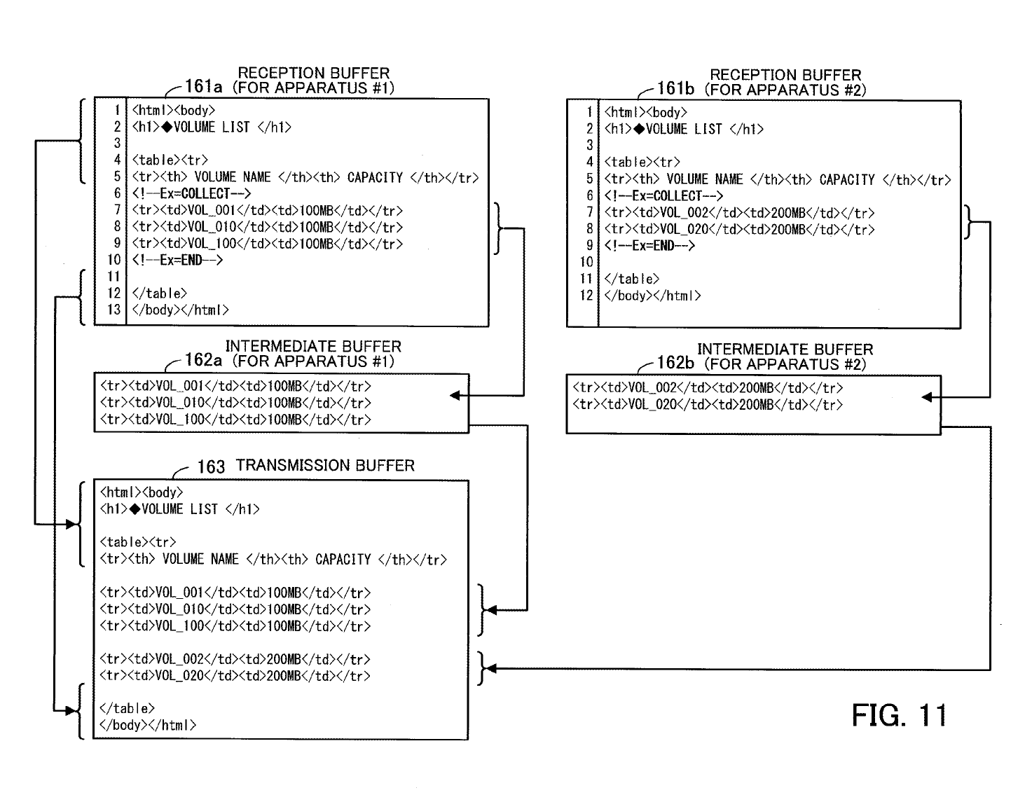

FIG. 11 illustrates an exemplary conversion of HTML data including “Ex=COLLECT”. It is assumed in FIG. 11 that there are two tape library apparatuses 100, as an example.

The HTML data illustrated in FIG. 11 is data for listing the volume name and the capacity of a logical volume registered in each tape library apparatus 100 as a “volume list” on the Web screen. The reception buffer 161a stores HTML data which has been output from the apparatus #1, and the reception buffer 161b stores HTML data which has been output from the apparatus #2.

Existence or absence of a conversion keyword is determined in sequence from the first line of the HTML data of the apparatus #1 by repeating the process of steps S102 to S105 of FIG. 10, and it is determined that a conversion keyword “Ex=COLLECT” is written in the sixth line. The conversion keyword “Ex=COLLECT” instructs to combine sets of HTML data which have been output from all the tape library devices 100 in a conversion range staring from the next line. The HTML conversion processing unit 143 performs the following processing after outputting the first to fifth line of the HTML data of the apparatus #1 to the transmission buffer 163.

First, the HTML conversion processing unit 143 outputs, to the intermediate buffer 162a corresponding to the apparatus #1, a range in the HTML data of the apparatus #1 from the seventh line next to the line where the conversion keyword “Ex=COLLECT” is written to the ninth line immediately preceding the line where the conversion keyword “Ex=End” is written. Next, the HTML conversion processing unit 143 outputs, to the intermediate buffer 162b corresponding to the apparatus #2, a range in the HTML data of the apparatus #2 from the seventh line next to the line where the conversion keyword “Ex=COLLECT” is written to the eighth line immediately preceding the line where the conversion keyword “Ex=End” is written.

Next, the HTML conversion processing unit 143 outputs the content of the intermediate buffers 162a and 162b sequentially to the transmission buffer 163. Accordingly, the sets of HTML data respectively from the apparatuses #1 and #2 within the conversion range are combined. Subsequently, the HTML conversion processing unit 143 outputs, to the transmission buffer 163, a range from the eleventh line to the last line of the HTML data of the apparatus #1. In this manner, the HTML data stored in the transmission buffer 163 becomes the converted HTML data.

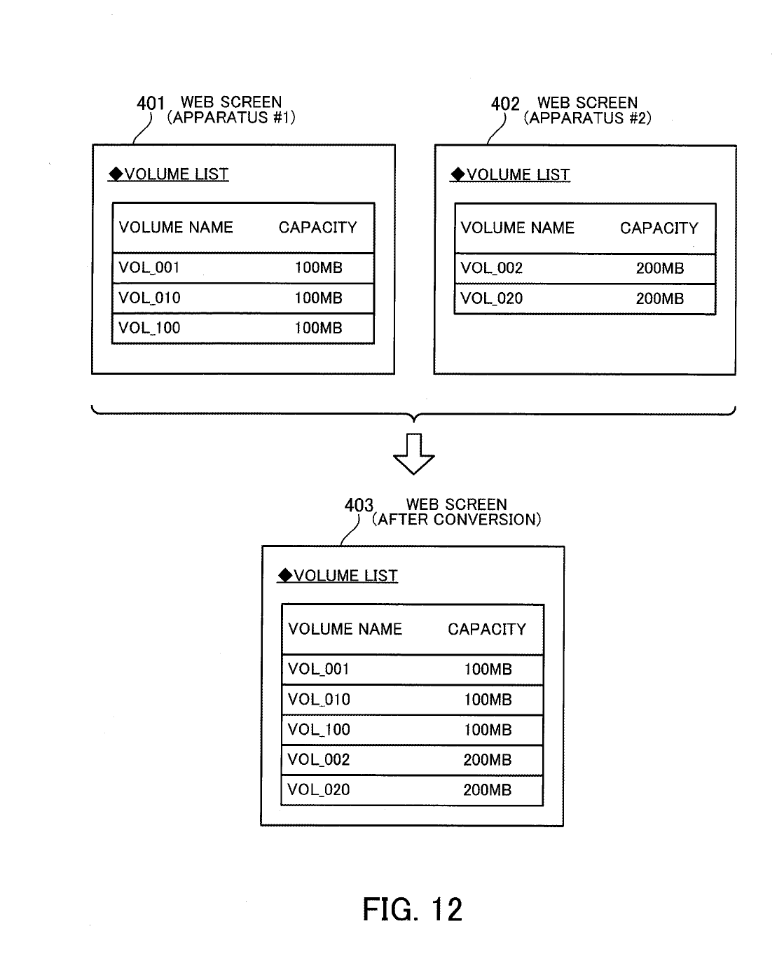

FIG. 12 illustrates an exemplary display of the Web screen corresponding to FIG. 11.

A Web screen 401 is an exemplary screen displayed on a Web browser based on the HTML data which has been output from the apparatus #1. The Web screen 401 indicates that the apparatus #1 has logical volumes “VOL_001”, “VOL_010” and VOL_100″ registered therein, and the capacities of respective logical volumes are all 100 MB. The logical volume names and the capacity values have been extracted by the maintenance processing unit 130 of the apparatus #1.

In addition, a Web screen 402 is an exemplary screen displayed on the Web browser based on the HTML data which has been output from the apparatus #2. The Web screen 402 indicates that the apparatus #2 has logical volumes “VOL_002” and “VOL_020” registered therein, and the capacities of respective logical volumes are all 200 MB. The logical volume names and the capacity values have been extracted by the maintenance processing unit 130 of the apparatus #2.

A Web screen 403 is an exemplary screen displayed on the Web browser based on the HTML data converted by the processing illustrated in FIG. 11. The Web screen 403 displays information related to the logical volumes “VOL_001”, “VOL_010” and “VOL_100”, followed by information related to the logical volumes “VOL_002” and “VOL_020”. Accordingly, the administrator may view the volume names and capacities of logical volumes registered respectively in the apparatuses #1 and #2 on a single screen and, for example, compare them easily, or sum up the total capacity.

In addition, the conversion range in the HTML data output from each apparatus is arbitrarily specified by the position where the conversion keywords “Ex=COLLECT” and “Ex=End” are written. In the example of FIG. 11, the conversion range is set at a position next to the line for displaying the column names “volume name” and “capacity”. Accordingly, only a single range with the column names “volume name” and “capacity” is displayed on the Web screen 403 based on the converted HTML data, followed by pieces of information aligned in parallel which have been output from the apparatuses #1 and #2, respectively.

Therefore, high-level conversion processing of sets of HTML data may be performed, in comparison with a case of simply combining the sets of HTML data which has been output from the apparatuses #1 and #2 respectively. For example, it is possible to suppress display of useless information on the screen, providing the administrator with an easy-to-view screen. In addition, it is also possible to present information on a plurality of tape library apparatuses 100 to the administrator in a manner as if viewing a piece of information on a single tape library apparatus 100.

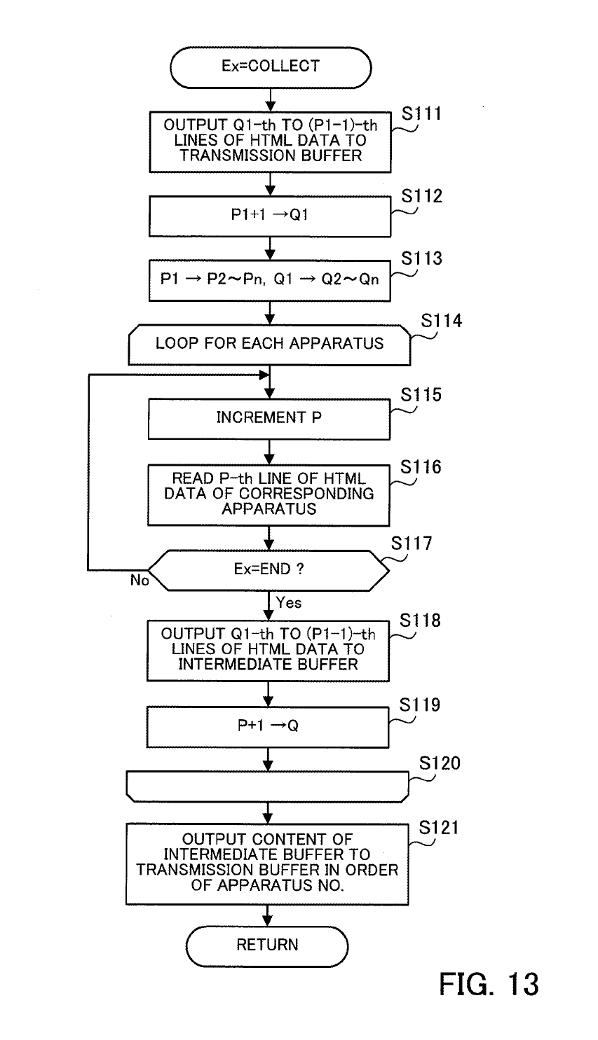

FIG. 13 is a flowchart illustrating exemplary data conversion processing when “Ex=COLLECT” is detected. FIG. 13 illustrates the processing executed at step S106 when the conversion keyword “Ex=COLLECT” is detected at step S105 of FIG. 10.

[Step S111] The HTML conversion processing unit 143 outputs a range from the Q1-th line to the (P1−1)-th line of the HTML data of the apparatus #1, from the reception buffer 161 corresponding to the apparatus #1 to the transmission buffer 163.

[Step S112] The HTML conversion processing unit 143 sets, to the pointer Q1, a value resulting from adding “1” to the pointer P1.

[Step S113] The HTML conversion processing unit 143 sets the value of the pointer P1 to the pointers P2 to Pn corresponding to other tape library apparatuses 100, and sets the value of the pointer Q1 to the pointers Q2 to Qn corresponding to other tape library apparatuses 100.

[Step S114] The HTML conversion processing unit 143 performs the processing up to step S120 which is the loop end for each tape library apparatus 100. The order of processing is assumed to be the order of ID numbers of the tape library apparatuses 100, for example.

[Step S115] The HTML conversion processing unit 143 increments the pointer P corresponding to the apparatus to be processed by “1”. For example, when the apparatus #2 is to be processed, the pointer P2 is incremented by “1”.

[Step S116] The HTML conversion processing unit 143 reads the P-th line of the HTML data of the apparatus to be processed. For example, when the apparatus #2 is to be processed, the P2-th line of the HTML data of the apparatus #2 is read.

[Step S117] The HTML conversion processing unit 143 determines whether the content which has been read at step S116 is the conversion keyword “Ex=END”. When it is “Ex=END”, the process of step S118 is performed, whereas the process flow returns to the process of step S115 when it is not “Ex=END”.

[Step S118] The HTML conversion processing unit 143 outputs a range from the Q-th line to the (P−1)-th line of the HTML data of an apparatus to be processed, from the reception buffer 161 corresponding to the apparatus to the intermediate buffer 162 corresponding to the apparatus. For example, when the apparatus #2 is to be processed, the Q2-th line to the (P2−1)-th line of the HTML data of the apparatus #2 is output from the reception buffer 161 corresponding to the apparatus #2 to the intermediate buffer 162 corresponding to the apparatus #2.

[Step S119] The HTML conversion processing unit 143 sets, to the pointer Q corresponding to the apparatus to be processed, a value resulting from adding “1” to the pointer P corresponding to the apparatus to be processed. For example, when the apparatus #2 is to be processed, the value (P2+1) is set to the pointer Q2.

[Step S120] Upon completion of processing over all the tape library apparatuses 100, the HTML conversion processing unit 143 performs the process of step S121. This brings about a state in which the sets of HTML data within the conversion range are stored in the intermediate buffers 162 corresponding to all the tape library apparatuses 100.

[Step S121] The HTML conversion processing unit 143 outputs the content of respective intermediate buffers 162 to the transmission buffer 163 in the order of ID numbers of the apparatuses.

Next, the conversion keyword “Ex=ONLY_ONE” will be described.

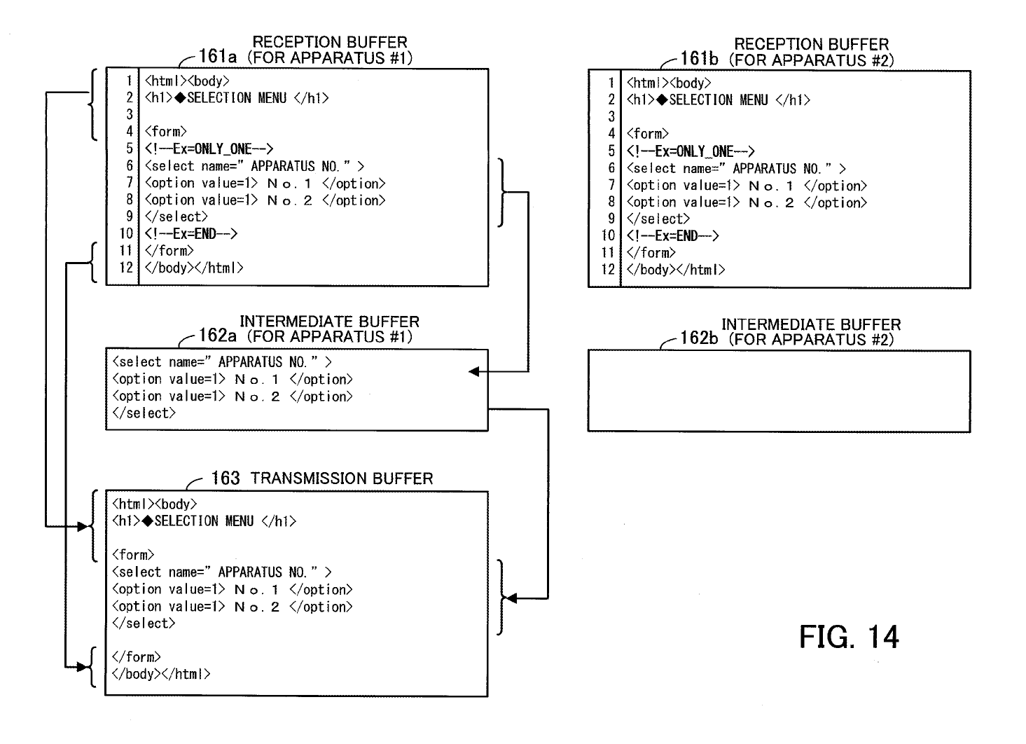

FIG. 14 illustrates an exemplary conversion of HTML data including “Ex=ONLY_ONE”. It is assumed that in FIG. 14, there are two tape library apparatuses 100, as an example.

Existence or absence of a conversion keyword is determined in sequence from the first line of the HTML data of the apparatus #1 by repeating the process of steps S102 to S105 of FIG. 10, and it is determined that a conversion keyword “Ex=ONLY_ONE” is written in the fifth line. The conversion keyword “Ex=ONLY_ONE” explicitly instructs to leave only one of the conversion ranges starting from the line next to the conversion keyword since the contents thereof are the same for respective apparatuses.

For example, the HTML data illustrated in FIG. 14 is data for displaying “selection menu” for selecting an apparatus number (apparatus No.) on the Web screen. The apparatus to be selected on the “selection menu” is any of the tape library apparatuses 100 coupled together. Although the maintenance processing unit 130 of each tape library apparatus 100 may extract the ID number of any of the tape library apparatuses 100 coupled together by referring to the system configuration information 152 of its home apparatus, for example, the ID numbers extracted by each maintenance processing unit 130 (“No. 1” and “No. 2” in FIG. 14) are the same. Accordingly, it suffices to have a set of HTML data for displaying the “selection menu” cooresponding to a single apparatus.

Accordingly, the HTML conversion processing unit 143 performs the following processing after outputting the first line to the fourth line of the HTML data of the apparatus #1 to the transmission buffer 163. The HTML conversion processing unit 143 outputs, to the intermediate buffer 162a corresponding to the apparatus #1, a range of HTML data of the apparatus #1 from the sixth line next to the line where the conversion keyword “Ex=ONLY_ONE” is written to the ninth line immediately preceding the line where the conversion keyword “Ex=End” is written. In addition, the HTML conversion processing unit 143 skips the processing of HTML data corresponding to the other apparatus #2, and outputs the content of the intermediate buffer 162a to the transmission buffer 163. Accordingly, only the data for the apparatus #1 remains in the converted HTML data, with regard to the HTML data within the conversion range. Subsequently, the HTML conversion processing unit 143 outputs, to the transmission buffer 163, data within a range from the eleventh line to the last line of the HTML data of the apparatus #1.

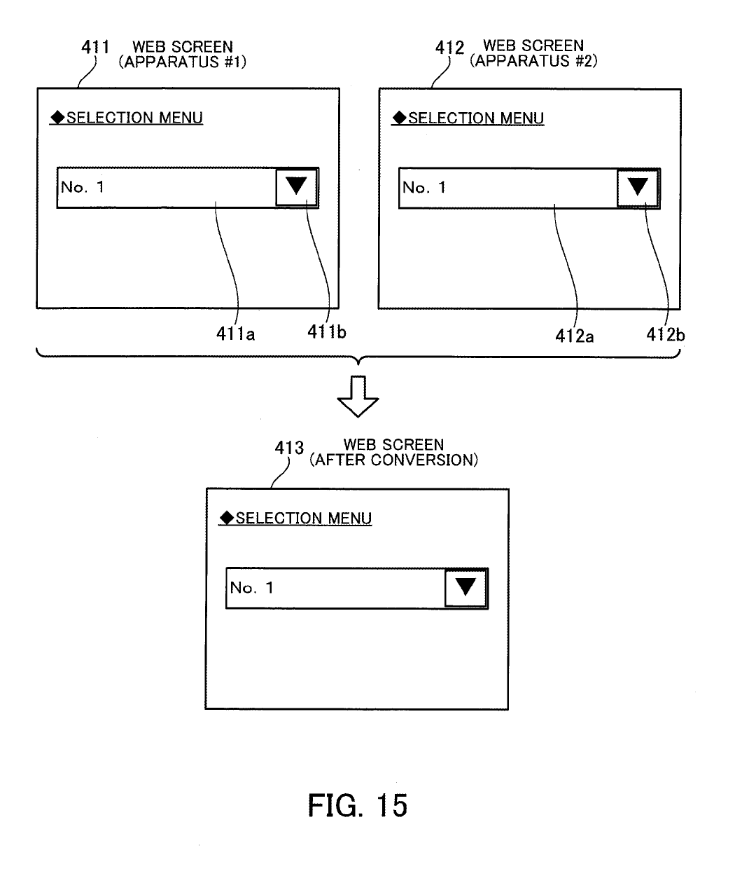

FIG. 15 illustrates an exemplary display of the Web screen corresponding to FIG. 14.

A Web screen 411 is an exemplary selection menu screen displayed on a Web browser based on the HTML data which has been output from the apparatus #1. The Web screen 411 has an information display area 411a and a button 411b displayed thereon. Although not illustrated, performing a mouse click operation on the button 411b causes a so-called “pull-down menu” listing options to be displayed. Information selected from the options by mouse operation is then displayed in the information display area 411a. In this example, the pull-down menu has displayed thereon identification information of respective tape library apparatuses 100 coupled together in the system as options.

The Web screen 412 is an exemplary selection menu screen displayed on a Web browser based on the HTML data which has been output from the apparatus #2. The Web screen 412 has displayed thereon an information display area 412a and a button 412b, similarly to the Web screen 411. In addition, the pull-down menu displayed by mouse click operation on the button 412b has displayed thereon identification information of respective tape library apparatuses 100 coupled together in the system as options, similarly to the Web screen 411.

As thus described, the sets of HTML data output from the respective apparatuses of #1 and #2 cause the same selection menu screen to be displayed and therefore simply coupling the sets of HTML data may cause two menus having the same options to be displayed on the screen based on the coupled set of HTML data. In contrast, writing the conversion keyword “Ex=ONLY_ONE” in the sets of HTML data allows the sets of HTML data to be integrated into a single set so that only one selection menu is displayed, as illustrated in the Web screen 413 of FIG. 15.

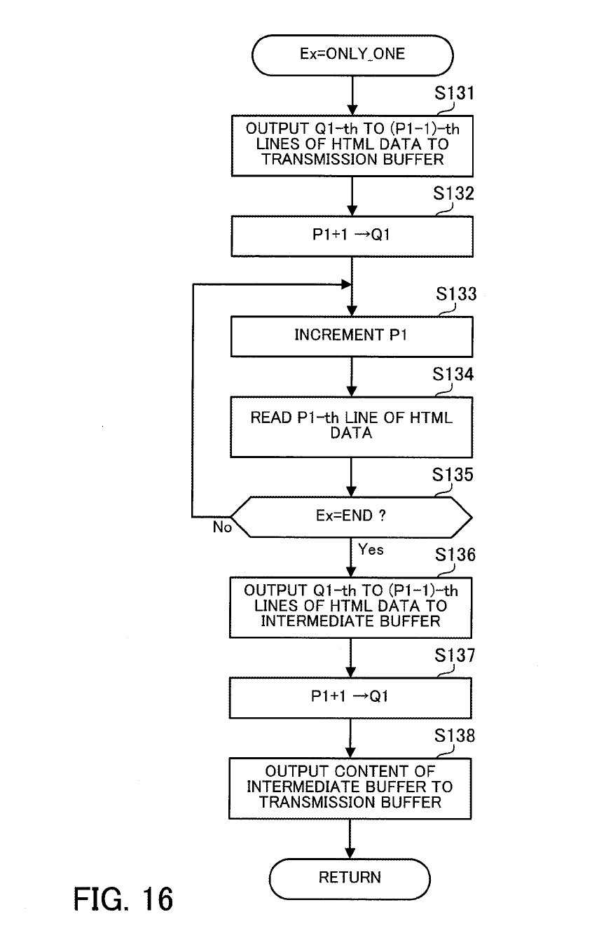

FIG. 16 is a flowchart illustrating exemplary data conversion processing when “Ex=ONLY_ONE” is detected. FIG. 16 illustrates the processing executed at step S106 when the conversion keyword “Ex=ONLY_ONE” is detected at step S105 of FIG. 10.

[Step S131] The HTML conversion processing unit 143 outputs a range from the Q1-th line to the (P1−1)-th line of the HTML data of the apparatus #1, from the reception buffer 161 corresponding to the apparatus #1 to the transmission buffer 163.

[Step S132] The HTML conversion processing unit 143 sets, to the pointer Q1, a value resulting from adding “1” to the pointer P1.

[Step S133] The HTML conversion processing unit 143 increments the pointer P1 by “1”.

[Step S134] The HTML conversion processing unit 143 reads the P1-th line of the HTML data of the apparatus #1.

[Step S135] The HTML conversion processing unit 143 determines whether the content read at step S134 is the conversion keyword “Ex=END”. When it is “Ex=END”, the process of step S136 is performed, whereas the process flow returns to the process of step S133 when it is not “Ex=END”.

[Step S136] The HTML conversion processing unit 143 outputs a range from the Q1-th line to the (P1−1)-th line of the HTML data of the apparatus #1, from the reception buffer 161 corresponding to the apparatus #1 to the intermediate buffer 162 corresponding to the apparatus #1.

[Step S137] The HTML conversion processing unit 143 sets, to the pointer Q1, a value resulting from adding “1” to the pointer P1.

[Step S138] The HTML conversion processing unit 143 outputs the content of the intermediate buffers 162 to the transmission buffer 163 in the order of ID numbers of the apparatuses.

Although the sets of HTML data within the conversion range are temporarily stored in the intermediate buffers 162 and thereafter output to the transmission buffer 163, in the exemplary processing of FIG. 16, the sets of HTML data within the conversion range may be directly output to the transmission buffer 163.

Next, the conversion keyword “Ex=SUBMIT” and a conversion keyword associated therewith will be described. The conversion keyword “Ex=SUBMIT” is written in the HTML data for displaying a form screen.

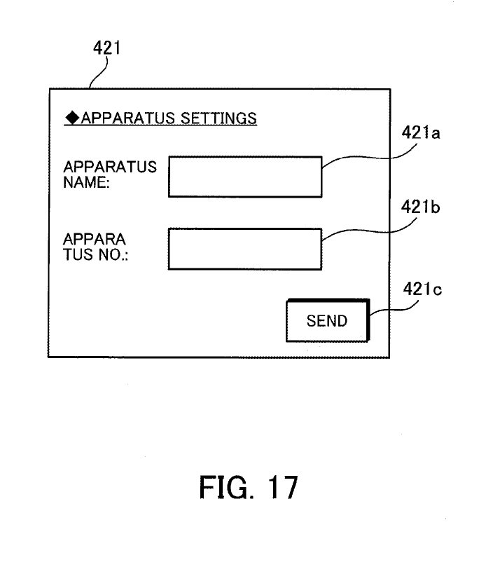

FIG. 17 illustrates an exemplary display of a form screen. The form screen includes an input information area for displaying input information and a send button for requesting transmission of the input information. A form screen 421 illustrated in FIG. 17 includes two input information areas 421a and 421b, and a send button 421c, as an example.

When information is input to the input information areas 421a and 421b, and a mouse-click operation, i.e., a submit operation is performed on the send button 421c, an HTTP request including the information input to the input information areas 421a and 421b, and a URL having written therein the program name of the CGI program to be called is transmitted to the Web server.

The program name of the CGI program to be called when a submit operation is performed is written in the original HTML data for displaying the form screen 421. As an exemplary conversion keyword, it is possible to specify a conversion method which changes the program name to an arbitrary program name, with regard to the HTML data having written therein the program name of the CGI program to be thus called at the time of a request.

Changing the program name written in the HTML data allows the master apparatus 100a which received the HTTP request from the management terminal 300 to call an arbitrary CGI program instead of the originally specified CGI program. The conversion keyword “Ex=SUBMIT” is thus an exemplary conversion keyword for specifying a conversion method which changes the program name of the CGI program to be called.

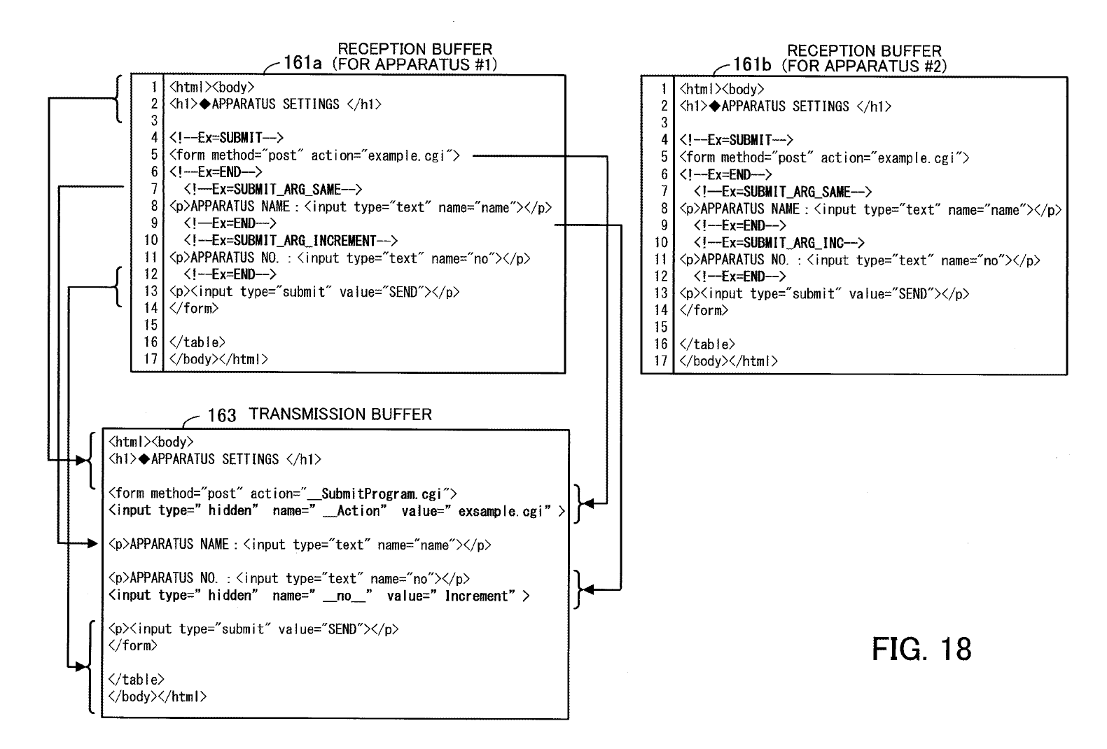

FIG. 18 illustrates an exemplary conversion of HTML data including “Ex=SUBMIT”. It is assumed that in FIG. 18, there are two tape library apparatuses 100, as an example.

The HTML data illustrated in FIG. 18 is data for displaying the form screen 421 illustrated in FIG. 17 on a Web browser. The reception buffer 161a stores the HTML data which has been output from the apparatus #1 and the reception buffer 161b stores the HTML data which has been output from the apparatus #2.

Existence or absence of a conversion keyword is determined in sequence from the first line of the HTML data of the apparatus #1 by repeating the process of steps S102 to S105 of FIG. 10, and it is determined that a conversion keyword “Ex=SUBMIT” is written in the fourth line. The conversion keyword “Ex=SUBMIT” instructs to rewrite the program name of the CGI program to be called to a predetermined program name, in the conversion range starting from the line next to the conversion keyword.

The HTML data of the apparatus #1 has “example.cgi” written, as the program name of the CGI program to be called, at the line next to the line where the conversion keyword “Ex=SUBMIT” is written. The HTML conversion processing unit 143 rewrites the program name “example.cgi” to the predetermined “_SubmitProgram.cgi”, and outputs it to the transmission buffer 163.

Furthermore, the HTML conversion processing unit 143 adds, to the line next to the line where the program name is rewritten, a statement having written therein a parameter to be passed when executing the CGI program corresponding to the rewritten program name. In the example of FIG. 18, a statement having written therein the program name “example.cgi” before conversion, as the parameter to be added. The aforementioned rewriting of the program name and addition of a new statement are performed only for the HTML data of the apparatus #1.

Additionally, in FIG. 18, “Ex=SUBMIT_ARG_SAME” and “Ex=SUBMIT_ARG_INCREMENT” are illustrated as exemplary conversion keywords associated with the conversion keyword “Ex=SUBMIT”.

The conversion keyword “Ex=SUBMIT_ARG_SAME” explicitly indicates that conversion of the HTML data within the conversion range is unnecessary. In the example of FIG. 18, therefore, the statement in the eighth line of the HTML data of the apparatus #1 is output, as is, to the transmission buffer 163.

The conversion keyword “Ex=SUBMIT_ARG_INCREMENT” instructs to convert the statement so that a value input to the corresponding input information area is incremented by “1” when being transferred to each tape library apparatus 100. Specifically, the parameter to be passed when executing the CGI program corresponding to the rewritten program name is added to the statement of the corresponding line. In the example of FIG. 18, “value=Increment” for instructing to increment the value input to the input information area of “apparatus No.” is added as the parameter. The aforementioned addition of the parameter is performed only for the HTML data of the apparatus #1.

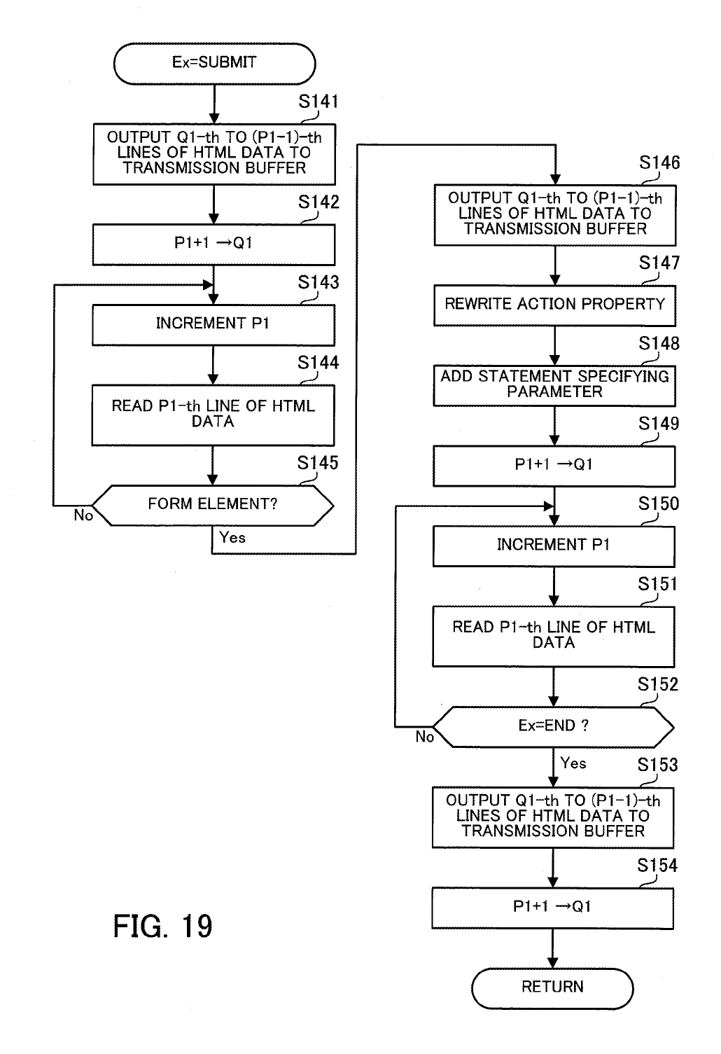

FIG. 19 is a flowchart illustrating exemplary data conversion processing when “Ex=SUBMIT” is detected. FIG. 19 illustrates the processing executed at step S106 when the conversion keyword “Ex=SUBMIT” is detected at step S105 of FIG. 10.

[Step S141] The HTML conversion processing unit 143 outputs a range from the Q1-th line to the (P1−1)-th line of the HTML data of the apparatus #1, from the reception buffer 161 corresponding to the apparatus #1 to the transmission buffer 163.

[Step S142] The HTML conversion processing unit 143 sets, to the pointer Q1, a value resulting from adding “1” to the pointer P1.

[Step S143] The HTML conversion processing unit 143 increments the pointer P1 by “1”.

[Step S144] The HTML conversion processing unit 143 reads the P1-th line of the HTML data of the apparatus #1.

[Step S145] The HTML conversion processing unit 143 determines whether the content read at step S144 is a statement specifying the property of the form element. When it is a statement specifying the property of the form element, the process of step S146 is performed, whereas the process flow returns to the process of step S143 when it is not a statement specifying the property of the form element.

[Step S146] The HTML conversion processing unit 143 outputs a range from the Q1-th line to the (P−1)-th line of the HTML data of the apparatus #1, from the reception buffer 161 corresponding to the apparatus #1 to the transmission buffer 163.

[Step S147] The HTML conversion processing unit 143 rewrites the program name written as the action property to “_SubmitProgram.cgi” in the statements of the P1-th line of the HTML data of the apparatus #1. The HTML conversion processing unit 143 outputs the rewritten statement to the transmission buffer 163.

[Step S148] The HTML conversion processing unit 143 generates a statement having written therein a parameter to be passed when executing the CGI program corresponding to the rewritten program name, and outputs the statement to the transmission buffer 163. Accordingly, the generated statement is added. In the added statement, the program name written in the statement of the P1-th line at step S147 is set as the value property.

[Step S149] The HTML conversion processing unit 143 sets, to the pointer Q1, a value resulting from adding “1” to the pointer P1.

[Step S150] The HTML conversion processing unit 143 increments the pointer P1 by “1”.

[Step S151] The HTML conversion processing unit 143 reads the P1-th line of the HTML data of the apparatus #1.

[Step S152] The HTML conversion processing unit 143 determines whether the content read at step S151 is the conversion keyword “Ex=END”. When it is “Ex=END”, the process of step S153 is performed, whereas the process flow returns to the process of step S150 when it is not “Ex=END”.

[Step S153] The HTML conversion processing unit 143 outputs a range from the Q1-th line to the (P1−1)-th line of the HTML data of the apparatus #1, from the reception buffer 161 corresponding to the apparatus #1 to the transmission buffer 163.

[Step S154] The HTML conversion processing unit 143 sets, to the pointer Q1, a value resulting from adding “1” to the pointer P1.

When the conversion keyword “Ex=SUBMIT_ARG_SAME” is detected at step S105 of FIG. 10, a procedure similar to FIG. 16 is performed.

In addition, when the conversion keyword “Ex=SUBMIT_ARG_INCREMENT” is detected at step S105 of FIG. 10, a procedure is performed with the flowchart of FIG. 19 being changed as follows.

At step S145, it is determined whether the content which has been read at step S144 is a statement specifying the property of the input element. At step S147, the statement of the P1-th line is output, as is, to the transmission buffer 163 without being rewritten. At step S148, a statement specifying an element similar to the statement of the P1-th line, i.e., the property of the input element, is added. In the added statement, “hidden” is set as the type property, “_no_” is set as the name property, indicating the same property as the name property written in the statement of the P1-th line, and “Increment” is set as the value property, instructing to increment the input value.

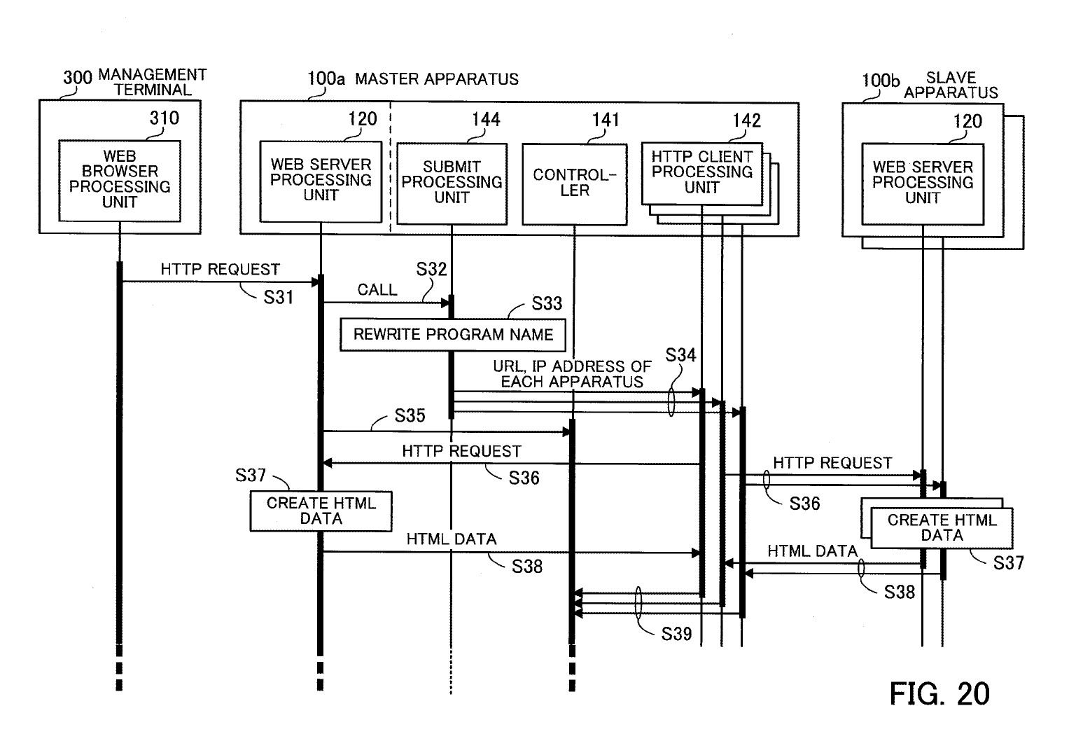

Next, a procedure will be described referring to FIG. 20 for a case of performing a submit operation under a condition that the HTML data converted as illustrated in FIG. 18 is transmitted to the management terminal 300 and a form screen based on the HTML data is displayed on the management terminal 300.

FIG. 20 is a sequence chart illustrating an exemplary process flow when an HTTP request is transmitted according to a submit operation. It is assumed that in FIG. 20, two slave apparatuses 100b are connected to the master apparatus 100a, as an example.

The Web browser processing unit 310 of the management terminal 300 transmits an HTTP request in response to a mouse-click operation (submit operation) on the send button (step S31).

On this occasion, the URL included in the HTTP request has specified therein the host name of one of the tape library apparatuses 100 (i.e., master apparatus 100a). In addition, the URL has “SubmitProgram.cgi” rewritten at step S147 of FIG. 19 set therein as the program name of the CGI program.

Furthermore, the HTTP request to be transmitted has the program name “example.cgi” based on the statement added at step S148 of FIG. 19 set therein as an argument to the CGI program specified in the URL. In addition, the HTTP request has “Increment” set as an argument corresponding to the value input to the input information area 421b of “apparatus No.”.

The Web server processing unit 120 of the master apparatus 100a receives an HTTP request addressed to its home apparatus from the management terminal 300. On this occasion, the Web server processing unit 120 determines to operate its home apparatus as the master apparatus 100a since the host name of its home apparatus is written in the URL. At the same time, upon detecting that the URL has set therein the program name of a CGI program which implements the processing of the submit processing unit 144, i.e., “SubmitProgram.cgi”, the Web server processing unit 120 calls the CGI program (step S32). Accordingly, the submit processing unit 144 is activated.

The submit processing unit 144 rewrites the program name being set in the received URL to the program name “example.cgi” which has been set as the argument (step S33). The submit processing unit 144 then activates as many HTTP client processing units 142 as the number of apparatuses registered in the system configuration information 152, i.e., the number of the tape library apparatuses 100 including its home apparatus (step S34).

When activating respective HTTP client processing units 142, the submit processing unit 144 notifies the respective activated HTTP client processing units 142 of the URL having the rewritten program name. In addition, the submit processing unit 144 notifies the respective activated HTTP client processing units 142 of different IP addresses from the IP addresses of respective devices registered in the system configuration information 152. Furthermore, the submit processing unit 144 sequentially notifies the respective HTTP client processing units 142 of the value which has been input to the input information area of “apparatus No.” included in the received HTTP request while incrementing the value by “1”, based on the argument “Increment”.

The submit processing unit 144 further notifies the controller 141 of completion of the processing (step S35). Upon receiving the notification, the controller 141 enters a state waiting for a response from each of the activated HTTP client processing units 142.

Each HTTP client processing unit 142 operates as a virtual client which issues a request to the corresponding tape library apparatus 100. In other words, each HTTP client processing unit 142 rewrites the host name in the URL notified from the submit processing unit 144 to the IP address of the corresponding apparatus notified from the submit processing unit 144. Each HTTP client processing unit 142 outputs an HTTP request including the rewritten URL to the Web server processing unit 120 of the corresponding apparatus (step S36).

Here, in the HTTP request to be output, the values input to the input information area of “apparatus No.” are different for respective output destination apparatuses. For example, in the form screen 421 of FIG. 17, the same value is transmitted to all the tape library apparatuses 100 as the input information corresponding to “apparatus name”, when “xxx” is input to the input information area 421a of “apparatus name” and “1” is input to the input information area 421b of “apparatus No.”. On the other hand, values incremented by “1” are transmitted to respective tape library apparatuses 100 such that a value “1” is transmitted to the apparatus #1, a value “2” is transmitted to the apparatus #2, and a value “3” is transmitted to the apparatus #3, with regard to the input value corresponding to “apparatus No.”. Accordingly, the same apparatus name will be requested to be set to respective tape library apparatuses 100.

Upon receiving an HTTP request including a URL having set therein the IP address of its home apparatus, the Web server processing unit 120 of the slave apparatus 100b causes the maintenance processing unit 130 of its home apparatus to perform the requested processing. The Web server processing unit 120 of the master apparatus 100a similarly causes the maintenance processing unit 130 of its home apparatus to perform the requested processing.

The maintenance processing unit 130 of each tape library apparatus 100 sets input apparatus name and the apparatus number in association with each other. Upon completion of the setting processing by the maintenance processing unit 130 in each tape library apparatus 100, the Web server processing unit 120 creates HTML data for displaying a Web screen which displays completion of setting (step S37). The templates used for creating the sets of HTML data by the Web server processing units 120 of respective tape library apparatuses 100 are the same.

The Web server processing unit 120 of each tape library apparatus 100 outputs the created HTML data to the corresponding HTTP client processing unit 142 in the master apparatus 100a (step S38). Each HTTP client processing unit 142 of the master apparatus 100a stores the received HTML data in the corresponding reception buffer 161, and notifies the controller 141 of completion of processing (step S39).

The processing after the controller 141 received the notice of completion of processing from all the activated HTTP client processing units 142 is basically the same as the processing at and after step S18 of FIG. 9. In other words, the HTML conversion processing unit 143 is activated, and the sets of HTML data are integrated into a single set of HTML data, based on the conversion keyword written in the sets of HTML data. The integrated single set of HTML data is then transmitted to the management terminal 300. Accordingly, the processing results in respective tape library apparatuses 100 are aggregated and displayed on a single Web screen on the Web browser of the management terminal 300.

In the second embodiment described above, the master apparatus 100a integrates the sets of HTML data output from respective tape library apparatuses 100 into a single set of HTML data, based on the conversion keywords embedded in respective sets of HTML data. Accordingly, it becomes possible for the administrator to browse the results of processing requested to respective tape library apparatuses 100 on the same screen displayed based on the integrated single set of HTML data.

In addition, the conversion range in the HTML data is specified by the position where the conversion keyword is embedded, and the master apparatus 100a performs the conversion processing over the specified conversion range in the HTML data, using the conversion method specified by the conversion keyword. Accordingly, it becomes possible to perform high-level conversion processing of HTML data which is different from a case of simply combining respective sets of HTML data.

In addition, there is no change for the processing function desired to be provided to at least the slave apparatus 100b, in comparison to the configuration in which the management terminal 300 directly accesses each tape library apparatus 100 as with the aforementioned reference example 1. In addition, it suffices, with regard to the master apparatus 100a, to provide the Web server processing unit 120 with a function of determining to operate as the master apparatus 100a, and add a program which implements the processing function of the HTML integrated processing unit 140. Therefore, the development man-hour of the tape library apparatus 100 may be reduced. Furthermore, since respective tape library apparatuses 100 may operate not only in the coupled state but also by being individually accessed from the management terminal 300, which results in an improved versatility.

The processing functions of the apparatuses (information processing apparatuses 1a to 1c, display apparatus 10, tape library apparatus 100, management terminal 300) illustrated in the aforementioned embodiments may be realized by a computer. In such a case, a program is provided having written therein the content of processing of the function which each apparatus is desired to have, and the processing function is implemented on a computer by executing the program on the computer. The program having written the content of processing may be stored in a computer-readable storage medium. The computer-readable storage medium may be a magnetic storage device, an optical disk, a magneto-optical storage medium, a semiconductor memory, or the like. The magnetic storage device may be a hard disk drive (HDD), a flexible disk (FD), a magnetic tape, or the like. The optical disk may be a DVD (Digital Versatile Disc), a DVD-RAM, a CD-ROM (Compact Disc-Read Only Memory), a CD-R (Recordable)/RW (Rewritable), or the like. The magneto-optical storage medium may be an MO (Magneto-Optical disk), or the like.

When distributing a program, a portable storage medium such as a DVD, CD-ROM, or the like having the program stored therein is put into the market, for example. Alternatively, a program may also be stored in a storage device of a server computer and transferred to other computers from a server computer via a network.

A computer configured to execute a program stores, in a storage device thereof, the program stored in a portable storage medium or the program transferred from a server computer, for example. The computer then reads the program from its storage device and performs the processing according to the program. The computer may also read the program directly from the portable storage medium and perform the processing according to the program. In addition, the computer may also perform sequentially, each time a program is transferred from the server computer connected via a network, the processing according to the received program.

According to an aspect, pieces of information acquired from a plurality of apparatuses may be collectively displayed on a screen.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising a processor configured to perform a procedure including:
acquiring sets of display data for displaying information from a plurality of apparatuses;
converting the sets of display data acquired from the plurality of apparatuses into a single set of display data by a conversion method based on additional information added to each set of display data; and
transmitting the converted set of display data to a display apparatus.

2. The information processing apparatus according to claim 1, wherein the converting the sets of display data includes converting data within a conversion range based on the same additional information added to each set of display data, in each of the sets of display data acquired from the plurality of apparatuses, by a conversion method based on the additional information.

3. The information processing apparatus according to claim 2, wherein the converting the sets of display data includes converting data within a conversion range based on the same additional information added to each set of display data in each of the sets of display data acquired from the plurality of apparatuses, to create converted data by a conversion method based on the additional information; and creating a single set of display data to be transmitted to the display apparatus by replacing, with the converted data, data within the conversion range based on the additional information in a set of display data acquired from one of the plurality of apparatuses.

4. The information processing apparatus according to claim 3, wherein a piece of the additional information is information instructing to combine data within the conversion range based on the additional information in each of the sets of display data acquired from the plurality of apparatuses.

5. The information processing apparatus according to claim 3, wherein a piece of the additional information is information instructing to add predetermined data to at least one set of data within the conversion range based on the additional information in each of the sets of display data acquired from the plurality of apparatuses.

6. The information processing apparatus according to claim 3, wherein a piece of the additional information is information instructing to replace particular information included in the conversion range based on the additional information in the set of display data acquired from one of the plurality of apparatuses with another predetermined information.

7. The information processing apparatus according to claim 3, wherein each of the sets of display data acquired from the plurality of apparatuses is data for displaying an operation screen which accepts input operation and, when a name of a program which requests execution according to an input operation on the operation screen is included in each of the acquired sets of display data, the converting the sets of display data includes replacing the name of the program included in the conversion range based on the additional information in the set of display data acquired from one of the plurality of apparatuses with a name of another predetermined program, based on the additional information added to each of the acquired sets of display data.

8. The information processing apparatus according to claim 1, wherein the acquiring the sets of display data includes distributing the processing request received from the display apparatus to the plurality of apparatuses and acquiring, from each of the plurality of apparatuses, a set of display data for displaying a result of processing performed according to the distributed processing request.

9. The information processing apparatus according to claim 8, wherein the converting the sets of display data includes converting the sets of display data acquired from the plurality of apparatuses into a single set of display data for displaying, in a row, pieces of information indicating results of processing performed in the plurality of apparatuses respectively, based on the additional information added to each of the acquired sets of display data.

10. The information processing apparatus according to claim 1, wherein:
one of the plurality of apparatuses is the information processing apparatus, and the rest of the plurality of apparatuses are other information processing apparatuses, and
the acquiring the sets of display data includes distributing the processing request received from the display apparatus to the information processing apparatus and each of the other information processing apparatuses, and acquiring sets of display data for displaying results of processing performed according to the distributed processing request, from the information processing apparatus and each of the other information processing apparatuses.

11. The information processing apparatus according to claim 1, wherein the additional information does not affect the process of displaying information based on a set of display data having the additional information added thereto.

12. An information processing method in an information processing system having a plurality of information processing apparatuses, the method comprising:
acquiring, by one information processing apparatus of the plurality of information processing apparatuses, sets of display data for displaying information from each of the other information processing apparatuses and from an inside of the one information processing apparatus; and
converting, by the one information processing apparatus, the acquired sets of display data into a single set of display data by a conversion method based on additional information added to each set of display data, and transmitting the set of converted display data to a display apparatus.

13. The information processing method according to claim 12, wherein the converting the sets of display data includes converting data within a conversion range based on the same above additional information added to each set of display data, in each of the acquired sets of display data, by a conversion method based on the additional information.

14. The information processing method according to claim 13, wherein the converting the sets of display data includes converting data within a conversion range based on the same additional information added to each set of display data, in each of the acquired sets of display data, to create converted data by a conversion method based on the additional information; and creating a single set of display data to be transmitted to the display apparatus by replacing, with the converted data, data within the conversion range based on the additional information in one of the acquired sets of display data.

15. The information processing method according to claim 14, wherein a piece of the additional information is information instructing to combine data within the conversion range based on the additional information in each of the acquired sets of display data.

16. The information processing method according to claim 14, wherein a piece of the additional information is information instructing to add predetermined data to at least one set of data within the conversion range based on the additional information in each of the acquired sets of display data.

17. The information processing method according to claim 14, wherein a piece of the additional information is information instructing to replace particular information included in the conversion range based on the additional information in one of the acquired sets of display data with another predetermined information.

18. The information processing method according to claim 12, wherein the acquiring the sets of display data includes distributing the processing request received from the display apparatus to each of the other information processing apparatuses and the one information processing apparatus, and acquiring sets of display data for displaying results of processing performed according to the distributed processing request, from each information processing apparatus of a distribution destination.

19. The information processing method according to claim 18, wherein the converting the sets of display data includes converting the acquired sets of display data into a single set of display data for displaying, in a row, pieces of information indicating results of processing respectively performed in information processing apparatuses of distribution destinations of the processing request, based on the additional information added to each set of display data.

20. A non-transitory computer-readable storage medium storing an information processing program, the information processing program causing a computer to perform a procedure comprising:
acquiring sets of display data for displaying information from a plurality of apparatuses;
converting the sets of display data acquired from the plurality of apparatuses into a single set of display data by a conversion method based on additional information added to each set of display data; and
transmitting the converted set of display data to a display apparatus.
